(19) United States
(12) Patent Application Publication
(10) Pub. No.: US 2026/0247114 A1
(43) Pub. Date: Aug. 20, 2026

(54) SYSTEM AND METHOD FOR COMMUNICATING 5G NAS MESSAGES USING SHORT MESSAGE SERVICE FUNCTION

(71) Applicant: JIO PLATFORMS LIMITED, Ahmedabad, Gujarat (IN)

(72) Inventors: Kumar Gaurav SINGH, Panvel, Maharashtra (IN); Aayush BHANTAGAR, Navi Mumbai, Maharashtra (IN); Arun DEWNA, Jaipur, Rajasthan (IN); Aarthi MUTHUPANDI, Kalyan West, Maharashtra (IN)

(73) Assignee: JIO PLATFORMS LIMITED, Ahmedabad, Gujarat (IN)

(21) Appl. No.: 18/992,591

(22) PCT Filed: Feb. 16, 2024
(86) PCT No.: PCT/IN2024/050169

§ 371 Date: Jan. 9, 2025

(30) Foreign Application Priority Data
Feb. 24, 2023 (IN) 202321012784

(51) Int. Cl. H04W 4/14; H04L 67/02

(52) U.S. Cl. CPC H04W 4/14; H04L 67/02

(57) ABSTRACT

The disclosed system and method enables communication of 5G Non-Access Stratum (NAS) messages in a communication network. In a 5G network, a Short Message Service Function (SMSF) (100) enables transfer of SMS over the NAS and the SMSF relays message between a User Equipment (UE) and a Short Message Service Center (SMSC) through Access and Mobility Management Function (AMF). The SMSF serves as an interface and a bridge between the 5G core network and a traditional SMSC for receiving and sending 5G NAS messages. The SMSF (100) offers services to the AMF via an Nsmsf service based interface.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of wireless networks, and specifically to a system and a method for communicating 5G Non-Access Stratum (NAS) messages using a Short Message Service Function (SMSF).

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

5G Short Message Service (SMS) relies heavily on a core network for legacy protocols and nodes. Usage of mobile networks may transform with 5G and new business cases for the SMS may emerge in 5G. One example is that of Internet of Things (IoT), whose number is projected to increase multifold in future. While 5G is primarily focused on providing faster, broader, and more widespread data services, it must also continue to support SMS messaging, which will remain important for the IoT services, over-the-air updates, multi-factor authentication, and communication with legacy networks.

To ensure that SMS is still supported in 5G networks, the 3GPP (3rd Generation Partnership Project) has developed standards that include use of a special node called SMS Function (SMSF). This node enables activation and delivery of the SMS within the 5G core and allows for exchange of SMS messages with legacy SMS servers and provisioning and activation of SMS services for 5G subscribers. However, the current available SMSF is not robust and hence not suitable enough to support majority of growth coming from massive IoT, which involves large volumes of low-cost devices that require low energy consumption as most operators rely on the SMSF for the SMS delivery.

There is, therefore, a need in the art for an improved and advanced architecture of the SMSF for communicating 5G Non-Access Stratum (NAS) messages.

### SUMMARY

In an exemplary embodiment, a method for providing node level redundancy for session data is described. The method comprises a short message service function (SMSF) cluster including plurality of SMSF nodes on a primary site with a service communication proxy (SCP). The SCP is configured to distribute the session data using a round robin algorithm. The method further comprises redirecting, by the SCP, the session data to other SMSF node from plurality of SMSF nodes, on detecting one of the plurality of SMSF nodes fails/downs. The method comprises triggering, by the SMSF, a disaster recovery (DR) site, on detecting all SMSF nodes fail/down. The method further comprises routing, by the SCP, the session data to the DR site. When the SMSF cluster is restarted and ready to accept the session data, sending a command line interface (CLI) command from the SMSF to the SCP to shift back the session data to primary site.

In some embodiments, the method further comprising integrating, by the SMSF, with plurality of network functions using a hypertext transfer protocol 2 (HTTP2) based interfaces both directly as well as via the SCP.

In some embodiments, the method further comprising enabling, by the SMSF, load distribution of messages by the SCP on plurality of SMSF blades.

In some embodiments, the method further comprising providing, by the SMSF, a mobile application part (MAP) connectivity via a mobile application part gateway (MAPGW) component.

In some embodiments, the method further comprising offering, by the SMSF, services to an access management function (AMF) via a NSMSF service-based interface.

In another exemplary embodiment, a method for providing database (DB) redundancy for traffic routing by is described. The method comprises a short message service function (SMSF) cluster containing plurality of DB nodes on a primary site with a service communication proxy (SCP). The plurality of DB nodes includes plurality of pairs of master DB node and slave DB node and an additional slave DB node. The SCP is configured to distribute the traffic using a round robin algorithm. The method further comprises routing, by the SMSF, traffic to the additional slave DB node on detecting master DB node or slave DB node of one pair of plurality of pairs of master DB nodes and slave DB nodes fails or goes down. The method comprises routing, by the SMSF, traffic to the other pair of plurality of pairs of master DB nodes and slave DB nodes on detecting one pair of plurality of pairs of master DB nodes and slave DB nodes fails or goes down. The method further comprises routing traffic, by the SCP, to a DR site on detecting all pairs of master DB nodes and slave DB nodes fail or down and the additional slave DB node is not available. When the SMSF cluster is restarted and ready to accept the traffic, sending a command line interface (CLI) command, by the SMSF, to the SCP to shift back the traffic to the primary site

In some embodiments, the SMSF is configured to integrate with plurality of network functions using a hypertext transfer protocol 2 (HTTP2) based interfaces both directly as well as via a service communication proxy (SCP)

In some embodiments, the SMSF is configured to enable load distribution of messages by the SCP on plurality of SMSF blades.

In some embodiments, the SMSF is configured to provide a mobile application part (MAP) connectivity via a mobile application part gateway (MAPGW) component.

In some embodiments, the SMSF is configured to offer services to an access management function (AMF) via a NSMSF service-based interface.

In yet another exemplary embodiment, a system for providing node level redundancy for session data is described. A short message service function (SMSF) cluster including plurality of SMSF nodes on a primary site with a service communication proxy (SCP). The SCP is configured to distribute the session data using a round robin algorithm. The SCP is configured to redirect the session data to other SMSF node from the plurality of SMSF nodes, on detecting one of the plurality of SMSF nodes fails/downs. The SMSF is configured to trigger a disaster recovery (DR) site, on detecting all the SMSF nodes fail/down. The SCP is configured to route the session data to the DR site. When the SMSF cluster is restarted and ready to accept the session data, the SMSF configured to send a command line interface (CLI) command to the SCP to shift back the session data to primary site.

In yet another exemplary embodiment, a system for providing database (DB) redundancy for traffic routing is described. A short message service function (SMSF) cluster containing plurality of DB nodes on a primary site with a service communication proxy (SCP). The plurality of DB nodes includes plurality of pairs of master DB node and slave DB node and an additional slave DB node, and the SCP is configured to distribute the traffic using a round robin algorithm. The SMSF is configured to route traffic to the additional slave DB node on detecting master DB node or slave DB node of one pair of plurality of pairs of master DB nodes and slave DB nodes fails or goes down. The SMSF is configured to route traffic to the other pair of plurality of pairs of master DB nodes and slave DB nodes on detecting the one pair of plurality of pairs of master DB nodes and slave DB nodes fails or goes down. The SCP is configured to route traffic to a DR site on detecting all pairs of master DB nodes and slave DB nodes fail or down and the additional slave DB node is not available. When the SMSF cluster is restarted and ready to accept the traffic, sending a command line interface (CLI) command, by the SMSF, to the SCP to shift back the traffic to the primary site.

The foregoing general description of the illustrative embodiments and the following detailed description thereof are merely exemplary aspects of the teachings of this disclosure and are not restrictive.

### Objects of the Present Disclosure

It is an object of the present disclosure to provide a system and a method to communicate 5G Non-Access Stratum (NAS) messages using a Short Message Service Function (SMSF).

It is an object of the present disclosure to enable the SMSF to transfer a SMS over the NAS.

It is an object of the present disclosure to enable the SMSF to relay a message between a User Equipment (UE) and a Short Message Service Center (SMSC) through Access and Mobility Management Function (AMF).

It is an object of the present disclosure to enable the SMSF to serve as an interface and bridge between a 5G core network and traditional SMSC for receiving and sending 5G NAS messages.

It is an object of the present disclosure to enable the SMSF to offer services to the AMF via an SMSF service based interface.

It is an object of the present disclosure to enhance the communication system.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an exemplary internal cluster architecture of advanced Short Message Service Function (SMSF), in accordance with an embodiment of the present disclosure.

FIG. 2 illustrates an exemplary the SMSF cluster primary/disaster recovery (DR) site, in accordance with an embodiment of the present disclosure.

FIG. 3 illustrates an exemplary one SMSF node/instance goes down, in accordance with an embodiment of the present disclosure.

FIG. 4 illustrates an exemplary two SMSF nodes/instances go down, in accordance with an embodiment of the present disclosure.

FIG. 5 illustrates an exemplary database redundancy, in accordance with an embodiment of the present disclosure.

FIG. 6 illustrates an exemplary the SMSF connection with other nodes via SCP, in accordance with an embodiment of the present disclosure.

FIG. 7 illustrates an exemplary the SMSF directly connected to other NF's, in accordance with an embodiment of the present disclosure.

FIG. 8 illustrates an exemplary the SMSF nodes/instances internal communication, in accordance with an embodiment of the present disclosure.

FIG. 9 illustrates an exemplary the SMSF to MAPGW communication, in accordance with an embodiment of the present disclosure.

FIG. 10 illustrates an exemplary MS connection with Central process, in accordance with an embodiment of the present disclosure.

FIG. 11 illustrates an exemplary SMSF configuration management architecture, in accordance with an embodiment of the present disclosure.

FIG. 12 illustrates an exemplary flow mechanism for User Equipment (UE) initial service activation/registration, in accordance with an embodiment of the present disclosure.

FIG. 13 illustrates an exemplary flow mechanism for the UE service deactivation/deregistration, in accordance with an embodiment of the present disclosure.

FIG. 14 illustrates an exemplary flow mechanism depicting Mobile Originated (MO) SMS procedure, in accordance with an embodiment of the present disclosure.

FIG. 15 illustrates an exemplary flow mechanism depicting Mobile Terminated (MT) SMS procedure, in accordance with an embodiment of the present disclosure.

FIGS. 16A-D illustrates an exemplary flow mechanism depicting 5G to 5G Short Message Service (SMS) procedure, in accordance with an embodiment of the present disclosure.

FIGS. 17A-B illustrates an exemplary flow mechanism depicting 5G to 5G unregistered user SMS procedure, in accordance with an embodiment of the present disclosure.

FIGS. 18A-B illustrates an exemplary flow mechanism depicting 5G to 4G SMS procedure, in accordance with an embodiment of the present disclosure.

FIGS. 19A-B illustrates an exemplary flow mechanism depicting a 5G subscriber to an international number SMS procedure, in accordance with an embodiment of the present disclosure.

FIGS. 20A-B illustrates an exemplary flow mechanism showing a 4G to 5G SMS procedure, in accordance with an embodiment of the present disclosure.

FIG. 21 illustrates an exemplary flow mechanism showing a registration flow for IP Multimedia Subsystem (IMS), in accordance with an embodiment of the present disclosure.

FIG. 22 illustrates an exemplary flow mechanism showing deferred delivery for a 5G user, in accordance with an embodiment of the present disclosure.

FIGS. 23A-B illustrates an exemplary 5G to offnet (2G/3G) SMS flow mechanism, in accordance with an embodiment of the present disclosure.

FIG. 24 illustrates an exemplary offnet (2G/3G) to 5G SMS flow mechanism, in accordance with an embodiment of the present disclosure.

FIG. 25 illustrates an exemplary offnet (2G/3G) to international subscriber SMS flow mechanism, in accordance with an embodiment of the present disclosure.

FIG. 26 illustrates an exemplary Network Function (NF) registration flow mechanism, in accordance with an embodiment of the present disclosure.

FIG. 27 illustrates an exemplary NF update flow mechanism (showing complete replacement), in accordance with an embodiment of the present disclosure.

FIG. 28 illustrates an exemplary NF update flow mechanism (showing partial replacement), in accordance with an embodiment of the present disclosure.

FIG. 29 illustrates an exemplary NF Heart-Beat flow mechanism, in accordance with an embodiment of the present disclosure.

FIG. 30 illustrates an exemplary NF deregister flow mechanism, in accordance with an embodiment of the present disclosure.

FIG. 31 illustrates an exemplary flow mechanism showing NF AccessToken Request, in accordance with an embodiment of the present disclosure.

FIG. 32 illustrates an exemplary flow mechanism showing NF Status Subscribe, in accordance with an embodiment of the present disclosure.

FIG. 33 illustrates an exemplary flow mechanism showing NF Status UnSubscribe, in accordance with an embodiment of the present disclosure.

FIG. 34 illustrates an exemplary flow mechanism showing NF StatusNotify, in accordance with an embodiment of the present disclosure.

FIG. 35 illustrates an exemplary flow mechanism showing NF discovery request, in accordance with an embodiment of the present disclosure.

FIG. 36 illustrates an exemplary flow mechanism showing SMSF-Security Edge Protection Proxy (SEPP) integration in accordance with an embodiment of the present disclosure.

FIG. 37 illustrates an exemplary computer system in which or with which embodiments of the present disclosure may be implemented.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

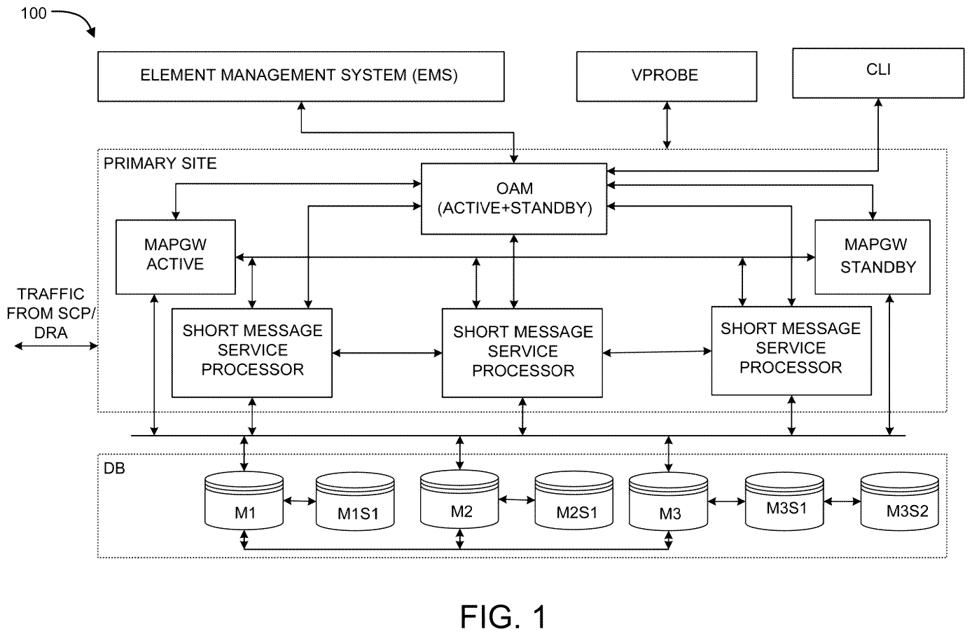

FIG. 1 illustrates an exemplary internal cluster architecture 100 of advanced Short Message Service Function (SMSF), in accordance with an embodiment of the present disclosure. In a 5G network, the SMSF (e.g., representing a short message server processor) enables transfer of Short Message Service (SMS) over Non-access stratum (NAS). In this capacity, the SMSF relays a message between a User Equipment (UE) and a Short Message Service Center (SMSC) through an Access and Mobility Management Function (AMF). The SMSF serves as an interface and a bridge between the 5G core network and traditional SMSC for receiving and sending 5G NAS messages. The SMSF offers services to the AMF via an SMSF service based interface. Here, the SMSF acts as producer where consumer is the AMF. In addition, the SMSF acts as the consumer for services offered by a Unified Data Management (UDM).

The SMSF supports following functionality to support the SMS over the NAS:
SMS management subscription data checking and conducting SMS delivery accordingly.
Relaying the Short Message (SM) from the UE towards the SMSC.
Relaying the SM from the SMSC towards the UE
Interaction with the AMF for a notification procedure that the UE is unavailable for SMS transfer.

The SMSF is a network entity in the 5G Core Network (5GC) and supports following functions:
Provides activation, deactivation of the UE
Registers and deregisters to Unified Data Management (UDM)
Maintains the UE context
Provides service of mobile originated and mobile terminated short message.
Registration and subscription services with Network Function Repository Function (NRF) for service discovery
Cell-ID and operator defined barring
LI integration, support of Hyper Text Transfer Protocol (HTTP2) based integration with IP Multimedia Subsystem (IMS)/IP Short Message Gateway (IP-SM-GW)
Horizontal scaling without service downtime, overload handling at all interfaces

The SMSF solution to function depends on following components:
Database (DB)
SMSF Module
Operations and Management (OAM)
Mobile Application Part Gateway (MAPGW)
SMSF Command Line Interface (SMSF CLI)

In an embodiment of the present invention, the disclosed SMSF configured for communicating 5G Non-Access Stratum (NAS) messages may be scalable and possess high resilience.

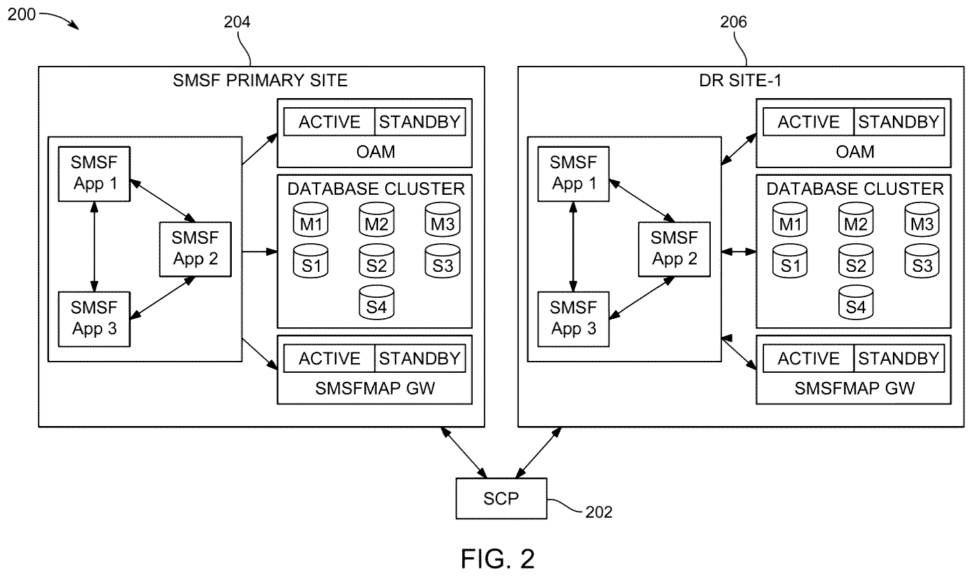

FIG. 2 illustrates an exemplary the SMSF cluster primary site (204)/disaster recovery (DR) site (206) with a service communication proxy (SCP), in accordance with an embodiment of the present disclosure. The disclosed SMSF configured for communicating 5G Non-Access Stratum (NAS) messages may be an optimized system, wherein no single point of failure which includes node level redundancy exists. In node level redundancy, the SMSF cluster having plurality of nodes (e.g., SMSF cluster with three nodes) is designed with the service communication proxy (SCP) (202) to distribute the workload evenly across its nodes.

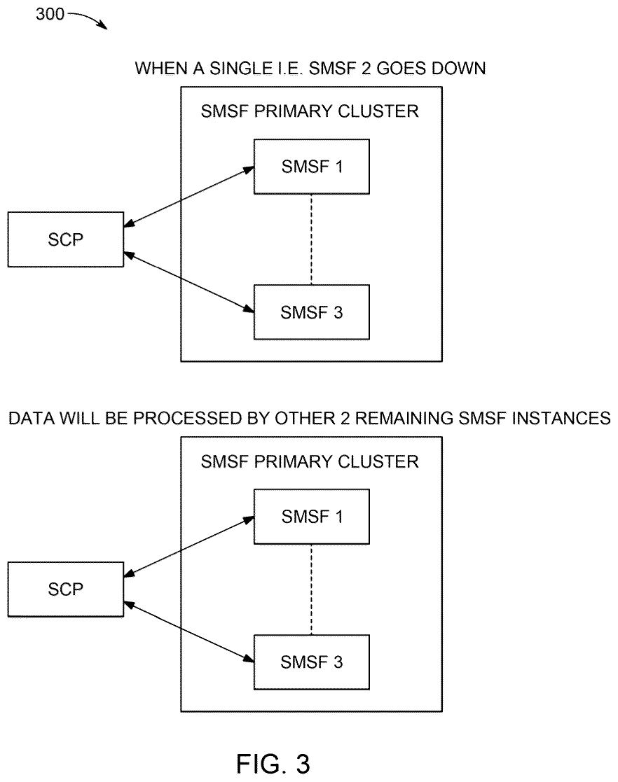

FIG. 3 illustrates an exemplary when one SMSF node/instance goes down 300, in accordance with an embodiment of the present disclosure. In case of a single SMSF node failure/down, the SCP may redirect traffic to the remaining two SMSF nodes present in the cluster. Thereby, preventing any interruption/failure in service.

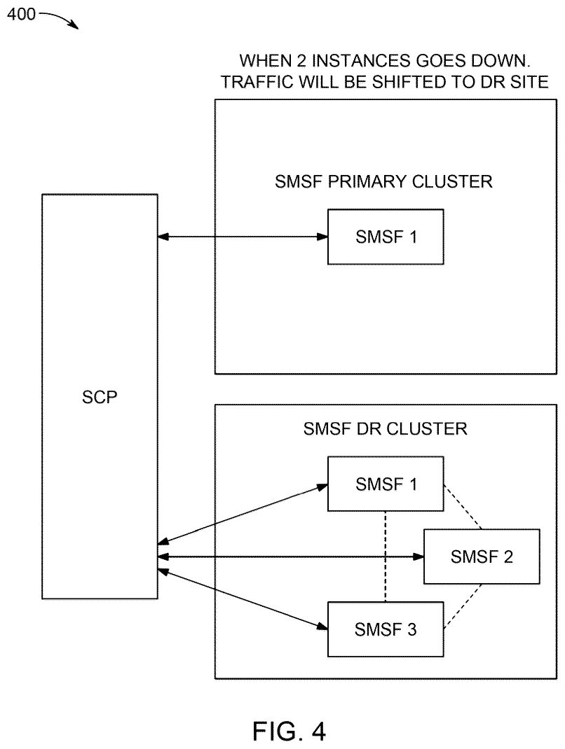

FIG. 4 illustrates an exemplary when two SMSF nodes/instances go down 400, in accordance with an embodiment of the present disclosure. In case two or all three SMSF nodes are down, this is considered as site failure. Then, a disaster recovery (DR) is triggered, and the SCP may route the traffic to the DR SMSF site.

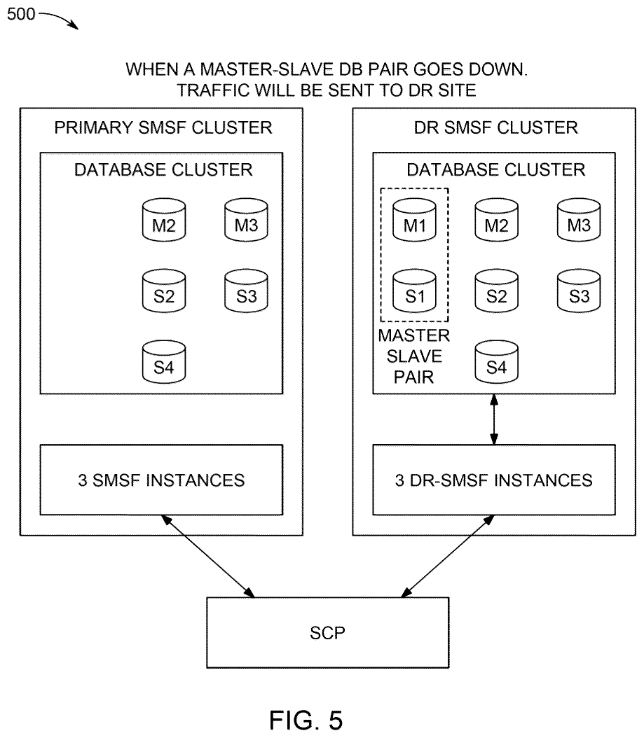

FIG. 5 illustrates an exemplary database redundancy 500, in accordance with an embodiment of the present disclosure. The SMSF may support database redundancy. A single SMSF cluster may contain plurality of database (DB) nodes (for example, seven DB nodes-three pairs of master and slave nodes and an additional slave node (e.g., a floating slave). The two master-slave node pairs (e.g., M1-S1 and M2-S2) and the third master node may contain two slave nodes (e.g., M3-S3, S4). If the master or slave node of any other master slave pair goes down then the extra slave node i.e., S4 will shift to that pair (e.g., if S1 goes down then S4 will become the new slave paired to M1). Further, the SMSF Cluster may handle two nodes failure of the same master-slave pair. If both paired master and slave node goes down and extra slave is not present to replace the node that has gone down, then the database (DB) cluster may consider as down. The traffic is routed to a disaster recovery (DR) SMSF cluster.

The disclosed SMSF integrates with other network functions for HTTP2 based interfaces both directly as well as via Service Communication Proxy (SCP).

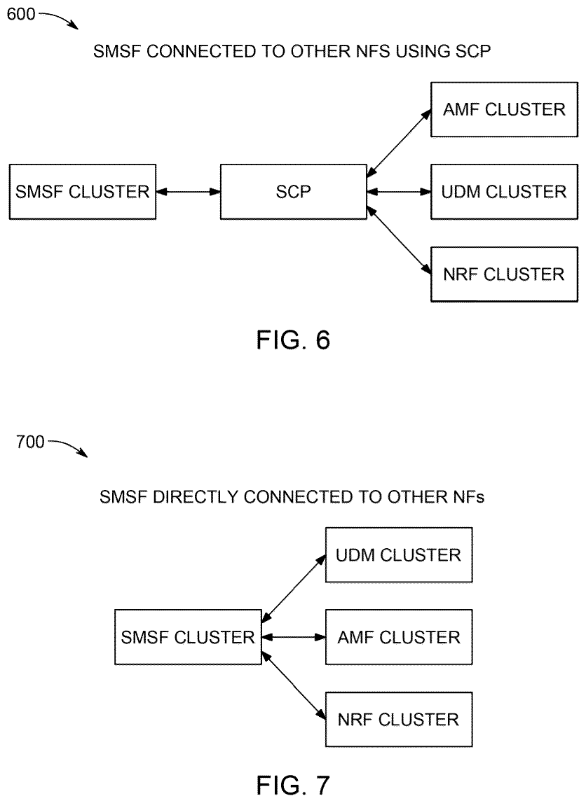

FIG. 6 illustrates an exemplary the SMSF connection with other nodes via SCP 600, in accordance with an embodiment of the present disclosure. For the SMSF connection with other nodes via SCP, the SMSF may communicate with UDM, AMF, NRF and SCP (5G network functions) using HTTP/2 protocol. In this way, the SCP may handle all the communication between SMSF and UDM/AMF/NRF clusters. The SMSF may send all the request/responses to SCP, which will further send them in round robin manner to the respective nodes.

FIG. 7 illustrates an exemplary the SMSF directly connected to other NF's 700, in accordance with an embodiment of the present disclosure. For the SMSF to directly connect to other NF's, the SMSF will directly send the message to the respective network functions (i.e., AMF, UDM, NRF) directly without any other node in middle.

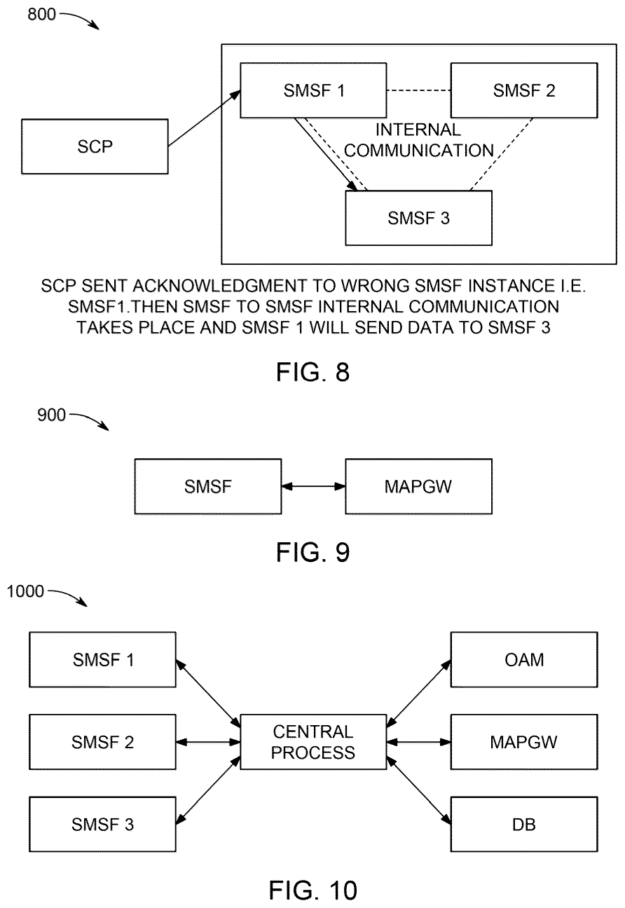

FIG. 8 illustrates an exemplary the SMSF nodes/instances internal communication 800, in accordance with an embodiment of the present disclosure. The disclosed SMSF configured for communicating 5G Non-Access Stratum (NAS) messages may be configured to enable uniform load distribution of messages by the SCP on multiple SMSF blades. The SCP may distribute load to the cluster in round robin fashion. For this, the acknowledgements (ACKs) arrive on a different SMSF instance altogether. The SMSF instance ensures the transaction is completed end to end by communicating the ACK to concerned SMSF instance using internal communication.

In an embodiment, the multiple database nodes (plurality of master and slaves, for example as shown: 3 master and 4 slave nodes) in the disclosed SMSF may provide full redundancy for session data.

FIG. 9 illustrates an exemplary the SMSF to MAPGW communication 900, in accordance with an embodiment of the present disclosure. The disclosed SMSF also provides Mobile Application Part (MAP) connectivity via the MAPGW component. The SMSF may provide support to connect with the legacy network using MAPGW component. When the SMSF receives a mobile originated (MO) message, the SMSF is configured to decide whether to forward the MO message on MAP (through MAPGW) or DIAMETER protocol (through SMSC/IPSMGW).

In an embodiment of the present invention the SMSF may provide support for disaster recovery SMSF using the SCP support. If one SMSF instance goes down, then SCP will check for other SMSF with same SET ID/PLMN and forwards the request to same cluster. If all serving SMSF instances belonging to the PLMN are down i.e., a SMSF cluster is down then the SCP will shift the traffic to a disaster recovery (DR) SMSF site, which is configured for the PLMN. Further, when the SMSF cluster is restarted and ready to accept the traffic then a command line interface (CLI) command is fired from the SMSF to the SCP to shift back the traffic to primary site. In this way, the SMSF may ensure that service continuity upon DR (e.g., if a user already attached to the primary site sends a message at the DR site, it's service will remain unaffected).

FIG. 10 illustrates an exemplary MS connection with Central process 1000, in accordance with an embodiment of the present disclosure. The SMSF may support zero touch installation through a central process. In the zero-touch installation approach, plurality of SMSFs are seamlessly deployed with configuration details across all network functions (NFs) in the cluster from a central source. Each NF instance along with its dependent component in the cluster may communicate with a central process of the central source. The central process may gather service availability status of each dependent component. The service status and internet protocol (IP) endpoints of each component is then passed on to others dependent components. Thereby, the cluster is created. The cluster has no dependency on the ordering/sequence of other related components. The components can come up in any sequence thus ensuring zero touch installation.

In an embodiment of the present invention, the disclosed SMSF may support lawful interception.

In an embodiment of the present invention, the disclosed SMSF may support Cell-ID and operator defined barring.

Henceforth, with the disclosed advanced SMSF, the communication of the 5G Non-Access Stratum (NAS) messages may be implemented using the disclosed flows in the present disclosure and the same may be advantageous for the efficient communication.

The SMSF is a main application that serves requests. The SMSF application as microservice is deployed in active-active-active for creating a complete cluster. The main purpose of the service manager application are as below:
Handle the HTTP2 signalling traffic to/from peer NFs.
Diameter connections with IPSM for a SGd interface.
Connectivity with database master for storing and retrieving Network Function (NF) specific data.
Interconnectivity with vProbe for transfer of Streaming Data Records (SDR).
Interconnectivity with the MAPGW
Interconnectivity with the OAM.

The Message Application Part (MAP) Gateway (GW) or the MAPGW is a micro service component responsible for creation of links towards legacy SMSC network via Signaling Transfer Point (STP) or direct. These Signaling System 7 (SS7) links may be used for transferring of SS7 MAP traffic with the SMSC/STP.

The OAM module is responsible for integration with Network Management Systems (NMS)/Element Management Systems (EMS) for fault, configuration, and performance management related services. Backup and restore functionality is also supported via the OAM.

A database node is used to store session data in a persistent database. The database components are divided into two sub components:
Database master node that is be responsible for handling requests for cache from an application. This acts as a level 2 cache.
Database slave node that saves a replicated copy of write requests and also handles read requests providing redundancy to the corresponding master node.

Disclosed system provides a separate Command Line Interface (CLI) for managing an application. The CLI or man-machine language (MML) is responsible for managing the application. Multiple command sets are available in the CLI for the user to manage configuration. These command sets include:
Parameter commands.
Counter commands
Alarm commands
Profile commands
NRF commands
Instrumentation commands
Application service operation commands

Performance management module is responsible as part of the OAM that is responsible for interacting with the SMSF application to fetch performance counters. This module also integrates with the performance management system via the NMS to transfer key performance indicators data specific to the SMSF cluster.

Configuration management module, as part of various micro services within the SMSF cluster, integrates with the configuration management system of the NMS via an OAM micro service which helps to push configuration changes into the SMSF cluster. The SMSF CLI is also exposed for purpose of configuration.

Fault management module integrates with the network management system to provide fault information for the specific SMSF cluster.

Logging service module is responsible for managing logging operations of the network function. Application operations, database access, software faults etc., are logged and managed using this module. This module also manages logging file rotation and purging.

Session database module integrates with database layer for performing creating, reading, updating and deletion operations of the session data related to the SMSF cluster.

Diameter stack management module is responsible for creating diameter connections with the IPSMGW for sending traffic over the SGd interface.

MAP stack management module is responsible for creating the SS7 connections with STP for sending the MAP traffic.

HTTP & HTTP2 stack management module is responsible for creating the HTTP/2 connections with Peer NFs. In addition, this module also maintains HTTP or HTTP/2 connections with various NBI such as vProbe/the NMS.

Call data record module is responsible for generation of Call Data Records (CDR) for the SMSF. The CDR generated may be integrated with mediation systems in case needed for billing purpose.

NRF client module as part of the SMSF application is responsible for interaction with the NRF directly or via the SCP Controller. This module provides various services such as NF management, NF discovery, and Access Token services with NRF.

UE context module as part of the SMSF is responsible for handling the UE context related functionality such as UE activation/deactivation/UE data retrieval/SMSF register for the UE etc.

Short Message Service module as part of a SMSF application is responsible for handling the uplink and downlink SMS related services.

Overload management module as part of the SMSF is responsible for providing overload control function for signalling interface.

vProbe management module is responsible for managing connectivity with the vProbe as well creation of the SDR that needs to be sent towards the vProbe. Possible error scenarios are mapped with the SDR and sent towards the vProbe using this module.

Replication module handles internal replication of data across various micro services which ensures that state data across microservices of same type is maintained and is coherent.

Health check Module is responsible for handling health check of the system. Further this module is also responsible for generating health check reports that can be used by operations.

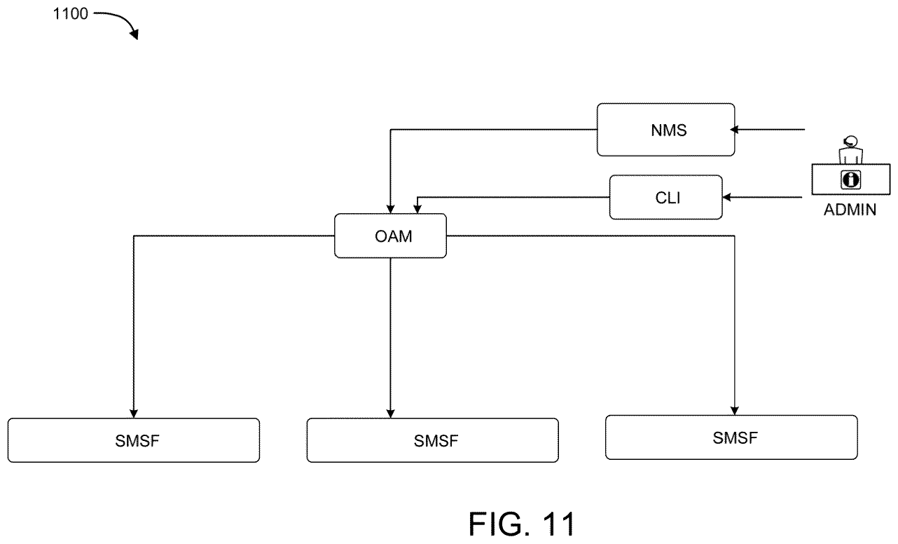

FIG. 11 illustrates an exemplary SMSF configuration management architecture 1100, in accordance with an embodiment of the present disclosure. The disclosed SMSF provides two different ways for configuration:
1) An admin or a pre-defined user can connect with the NMS system from which the SMSF cluster is to be configured. The NMS component internally talks to the OAM component on REpresentational State Transfer (REST) over the HTTP interface. The OAM supervises configuration of the SMSF cluster using proprietary interface.
2) The admin can also connect with the CLI for configuration management of the SMSF cluster.

In an embodiment is disclosed the SMSF services. Discussed below are service operations supported by the SMSF as a producer.

TABLE 1
The SMSF service operations

| | Service | |
|---|---|---|
| Services | Operations | Description |
| Nsmsf_SMService | Activate | Activate SMS service for a given |
| | | service user, which results in creating |
| | | or updating a UE context for SMS in |
| | | the SMSF. |
| | Deactivate | Deactivate SMS service for a given |
| | | service user, which results in deleting |
| | | a UE context for SMS in the SMSF. |
| | UplinkSMS | Send SMS payload in uplink |
| | | direction to the SMSF; |

Discussed below are features and functions for the NF.
AMF Services: Discussed below are the AMF services used by the SMSF

TABLE 2
The AMF services used by the SMSF

| Service Operations | Description |
|---|---|
| N1N2MessageTransfer | Used by SMSF for sending MT SMS towards |
| | AMF including Acknowledgement as well |
| | as Submit Reports. |
| EnableUEReachability | This procedure used for MT SMS is initiated |
| | by SMSF to enable the reachability of UE. |

UDM Services: Discussed below are the UDM services used by the SMSF

TABLE 3
UDM service used by the SMSF

| Service Operations | Description |
|---|---|
| UECM_Registeration | The SMSF registers with the UDM using |
| | Nudm_UECM_Registration with Access |
| | Type. As a result, the UDM stores the |
| | information such as SUPI, SMSF Identity, |
| | SMSF Address, Access Type. |
| UECM_DeRegisteration | The SMSF uses Nudm_UECM_Deregistration |
| | (SUPI, NF ID, Access Type) service |
| | operation from UDM to trigger UDM to delete |
| | the SMSF address of the UE for the impacted |
| | Access Type |
| SDM_Get | The SMSF may use SMS Management |
| | Subscription data (e.g., SMS teleservice, |
| | SMS barring list) using Nudm_SDM_Get |
| SDM_Subscribe | The SMSF subscribes to be notified using |
| | Nudm_SDM_Subscribe when the SMS |
| | Management Subscription data is modified |
| SDM_Notify | UDM sends notification towards the SMSF |
| | in case subscription for UE changes and the |
| | SMSF has subscribed to UDM. |

SGd Interface
SMSF provides support for following command codes for diameter based SGd interface.

TABLE 4
SGd interface messages

| Command Code | Description |
|---|---|
| OFR/OFA | This procedure is used between the SMSF and |
| | IPSMGW to forward mobile originated short |
| | messages from a mobile user to a Service Centre. |
| TFR/TFA | This procedure is used between the IPSMGW and |
| | SMSF to forward mobile terminated short messages. |

MAP Interface
The SMSF provides support for following command codes for diameter based SGd interface.

TABLE 5
MAP interface messages

| OpCode | Description |
|---|---|
| MO-FSM/MT- | Forward Short Message is used for both MO/MT SMS |
| FSM | procedures. |

NRF Services
Table below provides the NRF Services used by SMSF

TABLE 6
NRF service used by the SMSF

| Service Operations | Description |
|---|---|
| NFManage- | It allows an NF Instance to register its |
| ment_NFRegister | NF profile in the NRF. It includes the |
| | registration of the general parameters of |
| | the NF Instance, together with the list of |
| | services exposed by the NF Instance. |
| NFManage- | It allows NF Instance to deregister its |
| ment_NFDeregister | profile in the NRF, including the |
| | services offered by the NF Instance |
| NFManage- | It allows an SMSF instance to update |
| ment_NFUpdate | NF profile of SMSF instance previously |
| (Including Heartbeat) | registered in NRF. Further, each NF that |
| | has previously registered in NRF shall |
| | contact the NRF periodically (heart- |
| | beat), by invoking the NF Update |
| | service operation, in order to show that |
| | the NF is still operative. |
| NFManage- | It allows an SMSF instance to subscribe |
| ment_NFStatusSubscribe | to changes on the status of NF Instances |
| (Including Update) | registered in NRF. Further, SMSF |
| | instance can also update subscription of |
| | SMSF instance previously subscribed in |
| | NRF using Update procedure for same. |
| NFManage- | It allows an SMSF instance to delete |
| ment_NFStatusUnsubscribe | subscription of SMSF instance |
| | previously subscribed in NRF. |
| | Unsubscribed instances will no longer |
| | receive Status Notify. |
| NFManage- | This service operation notifies each |
| ment_NFStatusNotify | SMSF instance that was previously |
| | subscribed to receive notifications of |
| | registration/deregistration of NF |
| | Instances, or notifications of changes in |
| | the NF profile of a given NF Instance. |
| NFManage- | It allows an SMSF instance to retrieve a |
| ment_NFListRetrieval | list of NF Instances that are currently |
| | registered in NRF |
| NFManage- | This service operation allows the |
| ment_NFProfileRetrieval | retrieval of the NF profile of a given NF |
| | instance Id currently registered in NRF. |
| NFDiscovery_NFDiscover | This service operation discovers the set |
| | of NF Instances represented by their NF |
| | Profile of given NF type that are |
| | currently registered in NRF. |
| AccessToken_Get | For the authorized communication of |
| | SMSF instance with any other Node, |
| | SMSF instance may optionally send |
| | access token request to NRF with target |
| | details. SMSF also provides the Access |
| | Token Validation when acting as |
| | producer (via NRF as custom service) |

SCP Integration
The SMSF supports communication via the SCP. For communication with the NRF, the SCP controller is used. For communication with AMF or UDM, SCP proxy is used. Following headers are added for supporting the SCP integration via the SCP proxy.
   Routing towards AMF: 3gpp-sbi-discovery-target-nf-instance-id, 3gpp-Sbi-Discovery-target-plmn-list, 3gpp-Sbi-Discovery-target-nf-type.
   Routing towards UDM: 3gpp-Sbi-Discovery-target-nf-service-name, 3gpp-Sbi-Discovery-target-plmn-list, 3gpp-Sbi-Discovery-target-nf-type.
Roaming Partner UDM Discovery
The SMSF supports discovery for roaming partner UDM at the time of start-up or runtime based on user configuration done for roaming partner Public Land Mobile Network (PLMN).
UE GPSI/SUPI from UDM
Generic Public Subscription Identifier (GPSI) may be fetched from the UDM if not provided by the AMF during activation procedure using gpsi_to_supi translation API.
Security Edge Protection Proxy (SEPP) Integration
The SMSF integration with the SEPP is done for supporting all communication for foreign users/PLMNs. All communication with foreign UDM is done through the SCP via the SEPP.
High Availability
The SMSF is deployed using the Active-Active-Active architecture to provide the high available cluster. Further DR SMSF Cluster is supported for geographical redundancy requirement.
Health Check Automation
For ease of operations, the system supports automatic health check report generation that is supported by the SMSF.
PLMN Whitelisting
The SMSF supports the PLMN whitelisting feature which ensures that the SMSF only provides service for configured PLMNs only. Any PLMN which is not included in whitelist shall be rejected by the SMSF.
Traffic Steering—MAP vs Diameter
The SMSF provides steering of traffic towards the MAP or diameter based on user configuration. This provides flexibility by which the user can decide that for specific PLMN whether traffic should exit using the diameter or the MAP.
Performance Management
The system provides vast array of counters for service operations supported by it. Separate counters for the AMF, the UDM, the NRF and the SGd interface are provided by the SMSF. In addition, counters related to DB are also provided by the SMSF.
Fault Management
The OAM provides multiple alarms, which are based on system function as well as threshold-based alarms. These alarms are transferred to the NMS system for notification.
Log Management
The system provides a capability to change log level for various functions of the NF as per user requirement.
Configuration Management
The system provides configuration support via the CLI.

In an embodiment, are disclosed end-to-end call flows for various use cases:

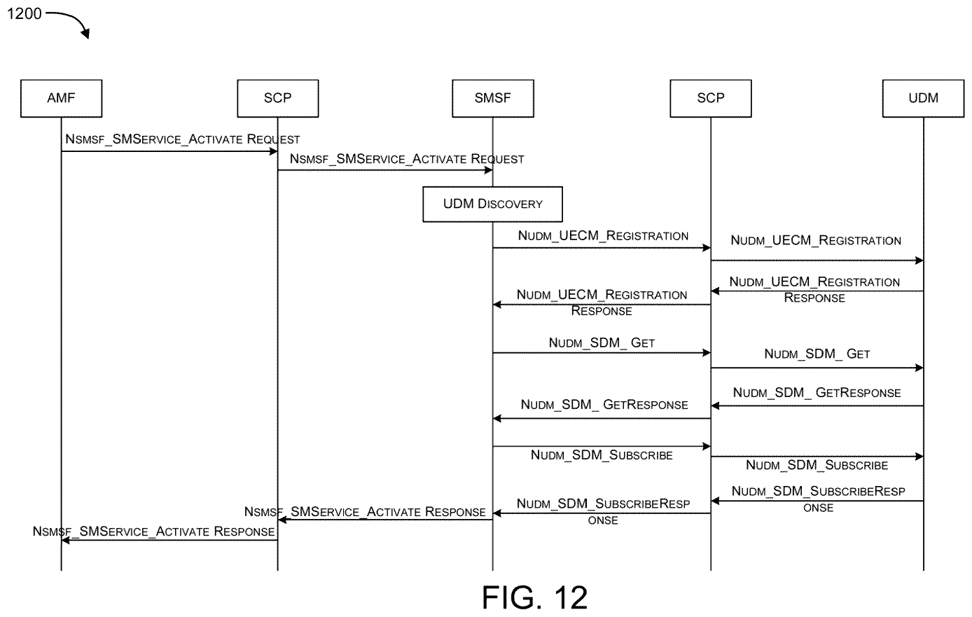

Activation/Registration: The UE initial service activation/registration procedure 1200 is disclosed in FIG. 12, in accordance with an embodiment of the present disclosure. The disclosed call flow indicates service activation for the SMS which happens during initial registration of the UE where the UE includes “SMS supported” indication as part of initial registration procedure. The procedure assumes that as part of initial registration, the AMF may have already retrieved subscription data and the UE context from the UDM or old AMF. Further subscription data indicates that the SMS service is allowed for the UE, while the UE context may include SMSF address. For SMSF address if not received as part of the UE context, then the AMF may be configured with the static SMSF address or may initiate NFDiscovery service towards the NRF for finding the SMSF address.
The AMF invokes Nsmsf_SMService_Activate service operation from the SMSF. The invocation includes AMF address, Access Type, RAT Type, GPSI (if available) and SUPI. AMF uses the SMSF Information derived.
The SMSF performs UDM discovery and selection through the NRF. The SMSF may use PLMN/SUPI/SUCI for the UDM selection.
If the UE context for the current access type already exists in the SMSF, then the SMSF shall replace the old AMF address with the new AMF address.
Otherwise, the SMSF registers with the UDM using Nudm_UECM_Registration with Access Type. As a result, the UDM stores the following information: SUPI, SMSF identity, SMSF address, Access Type in the UE context in SMSF data. The UDM may further store SMSF information in the UDR by Nudr_DM_Update (SUPI, subscription data, the UE context in the SMSF data).
The SMSF retrieves SMS management subscription data (e.g., SMS teleservice, SMS barring list) using Nudm_SDM_Get and this requires that the UDM may get this information from the UDR by Nudr_DM_Query (SUPI, Subscription Data, SMS Management Subscription data).
The SMSF subscribes to be notified using Nudm_SDM_Subscribe when the SMS management subscription data is modified and the UDM may subscribe to notifications from UDR by Nudr_DM_Subscribe. The SMSF also creates the UE context to store the SMS subscription information and the AMF address that is serving this UE.
The SMSF responds back to the AMF with Nsmsf_SMService_Activate service operation response message. The AMF stores the SMSF Information received as part of the UE context.

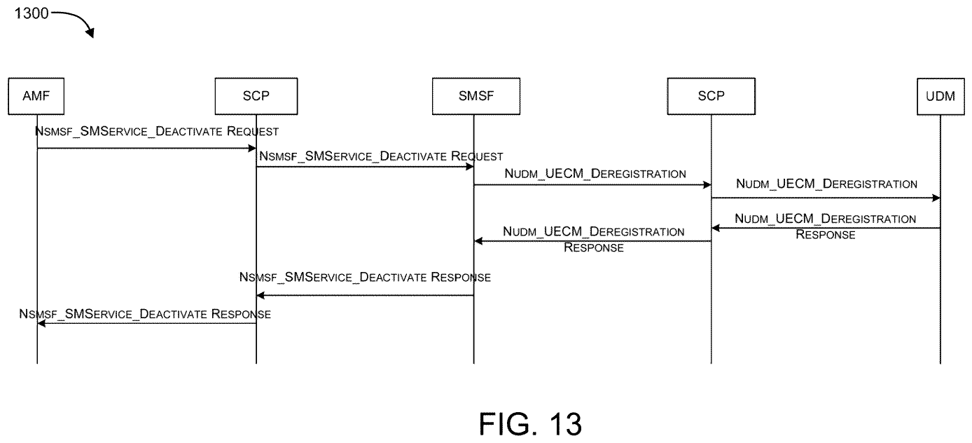

Deactivation/Deregistration: FIG. 13 illustrates an exemplary flow mechanism 1300 for UE service deactivation/deregistration, in accordance with an embodiment of the present disclosure. If the UE indicates to the AMF that it no longer wants to send and receive the SMS over the NAS (e.g., not including “SMS supported” indication in subsequent registration request message) or the AMF considers that the UE is deregistered on specific access type(s) or AMF receives deregistration notification from the UDM for specific access type(s) indicating the UE's initial registration, subscription withdrawn then the AMF will initiate deactivation/deregistration procedure.
The AMF invokes, for the impacted access type(s), Nsmsf_SMService_Deactivate service operation to trigger the release of UE context for SMS on the SMSF based on local configurations. Also, if the UE is not registered at other access type for the SMS over the NAS service at the AMF anymore, the AMF may delete or deactivate the stored SMSF address in its UE context.
The SMSF unsubscribes from SMS management subscription data changes notification with the UDM by means of the Nudm_SDM_unsubscribe service operation if the UE is not registered at other access type for the SMS over the NAS service at the SMSF anymore. The UDM may remove the corresponding subscription of data change notification in UDR by Nudr_DM_Unsubscribe service operation.
The SMSF shall invoke Nudm_UECM_Deregistration (SUPI, NF ID, Access Type) service operation from the UDM to trigger the UDM to delete the SMSF address of the UE for the impacted access type(s).
It may be noted, that standard provides flow where the SMSF unsubscribes (before DeRegisteration) from the SMS management subscription data changes notification with the UDM by means of the Nudm_SDM_Unsubscribe service operation if the UE is not registered at other access type for the SMS over the NAS service at the SMSF anymore. The UDM may remove the corresponding subscription of data change notification in the UDR by Nudr_DM_Unsubscribe service operation. This operation i.e., UnSubscribe shall not be performed by the SMSF as the UDM will implicitly remove subscription data upon receiving DeRegistration request (if SMSF has send implicit unsubscribe during Deregistration).
The SMSF sends Nsmsf_SMService_Deactivate response (204 Deleted/No Content) towards AMF. The SMSF also deletes stored UE context in database.

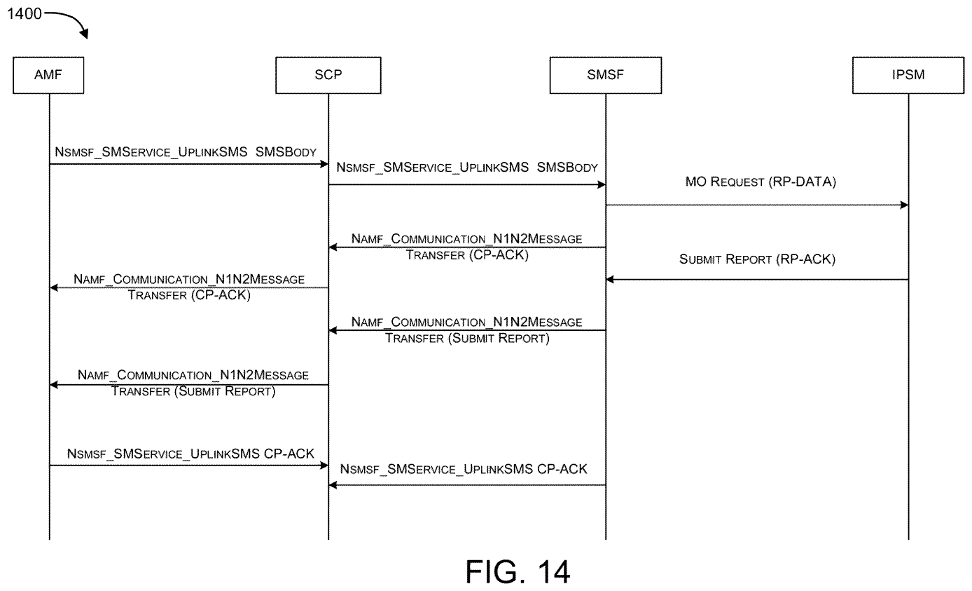

In an embodiment is disclosed a Mobile Originated (MO) SMS procedure. FIG. 14 illustrates an exemplary flow mechanism 1400 showing Mobile Originated (MO) SMS procedure, in accordance with an embodiment of the present disclosure.
Upon receiving the SMS data from the UE, the AMF forwards the SMS message and the SUPI to the SMSF serving the UE over N20 message by invoking Nsmsf_SMService_UplinkSMS service operation.
The SMSF invokes Namf_Communication_NIN2MessageTransfer service operation to forward SMS ack (CP-ACK) message to the AMF.
If the UE is served, the SMSF sends the forward MO request with RP-DATA to the SMSC.
The SMSC may respond back with a submit report (RP-ACK).
The SMSF forwards the submit report to the AMF by invoking Namf_Communication_NIN2MessageTransfer service operation. If the SMSF knows, the submit report is the last message to be transferred for the UE, the SMSF may include a last message indication in the Namf_Communication_NIN2MessageTransfer service operation so that the AMF knows no more SMS data is to be forwarded to the UE.
The AMF forwards the SMS ack message by invoking Nsmsf_SMService_UplinkSMS service operation (CP-ACK) to SMSF.

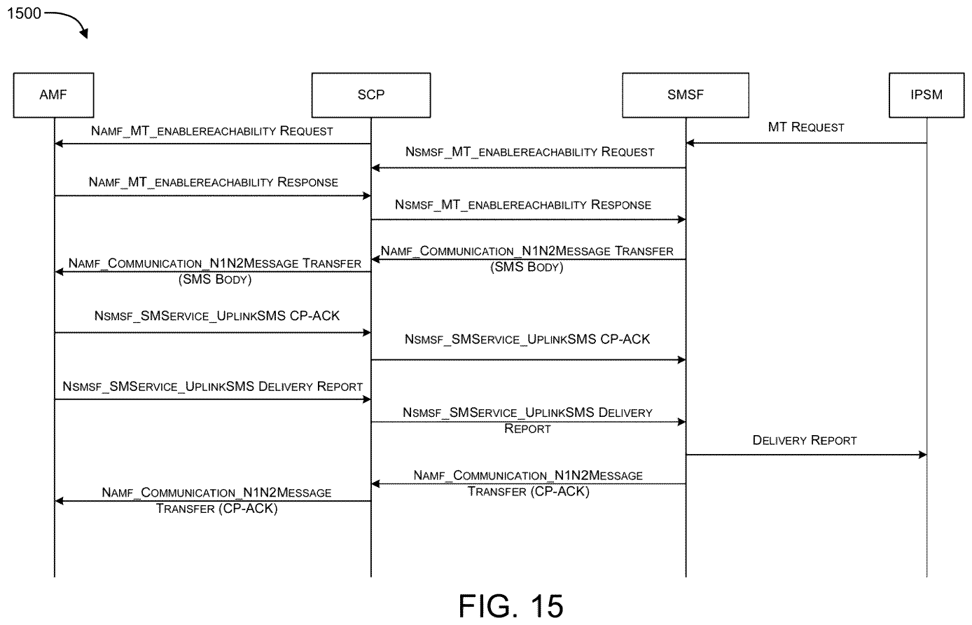

In an embodiment is disclosed a Mobile Terminated (MT) SMS procedure. FIG. 15 illustrates an exemplary flow mechanism 1500 showing Mobile Terminated (MT) SMS procedure, in accordance with an embodiment of the present disclosure.
Forward MT request is received from the SMSC and is forwarded to any one SMSF instance.
The SMSF checks the SMS management subscription data. If SMS delivery is allowed, the SMSF invokes Namf_MT_EnableUEReachability service operation to the AMF. It is to be noted that EnableUEReachability is sent based on configuration to avoid excess traffic.
The AMF pages the UE, in response to which the UE sends service request procedure based on which the AMF provides reachability response to the SMSF.
The SMSF forwards the SMS message to the AMF by invoking Namf_Communication_NIN2MessageTransfer service operation.
For uplink unit data message (CP-ACK) towards the SMSF, the AMF invokes Nsmsf_SMService_UplinkSMS service operation to forward the message to SMSF.
The AMF upon reception of delivery report from the UE, forwards the delivery report to the SMSF by invoking Nsmsf_SMService_UplinkSMS service operation.
The SMSF acknowledges receipt of the delivery report to the AMF by using Namf_Communication_NIN2MessageTransfer service operation to send SMS CP ack message to the AMF.

End to End SMS call flows: For successful end to end SMS, below mentioned assumptions are made which are supported in the existing network:
The UDM and the HSS are in sync.
The user is charged at the IPSMGW. The OCS has subscription data of 5G users as well.
The IPSMGW supports Sgd/S6c diameter interfaces in addition to existing SIGTRAN interface.
The IPSMGW gives priority to Sgd over sigtran for onnet terminating users.
The SMSF will be in visited domain and the IPSMGW will be in home domain.

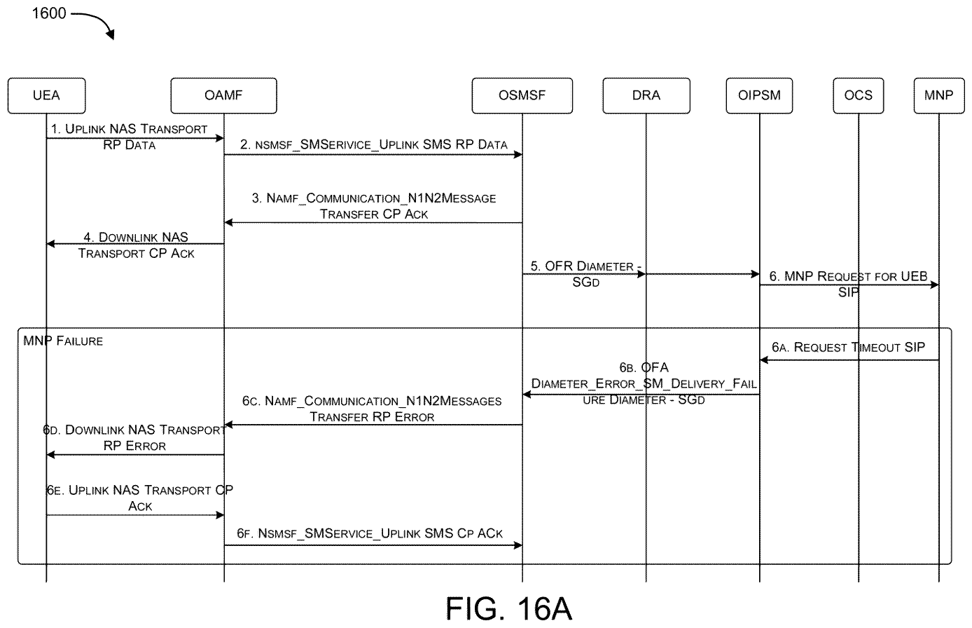

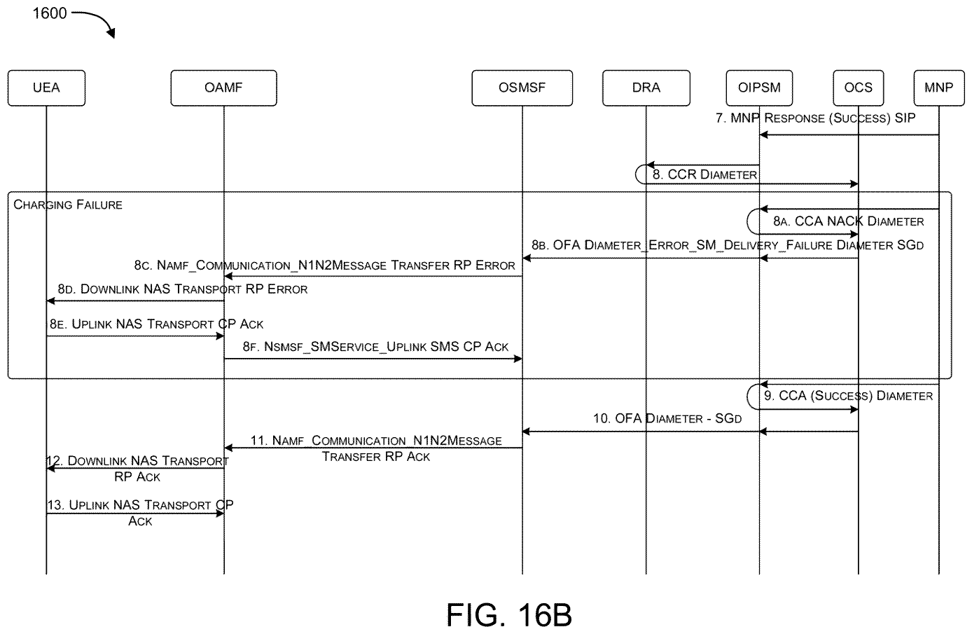

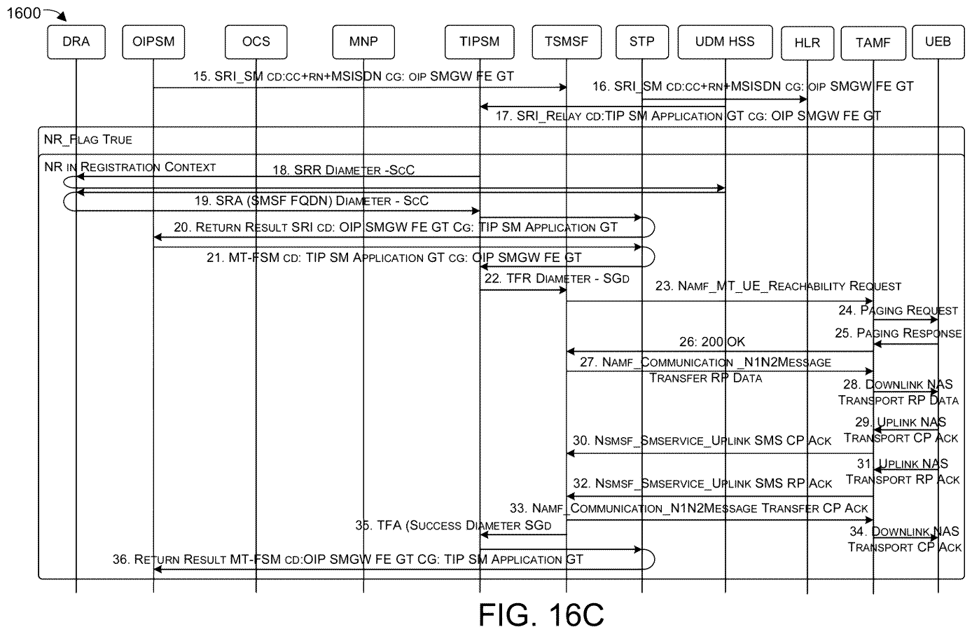

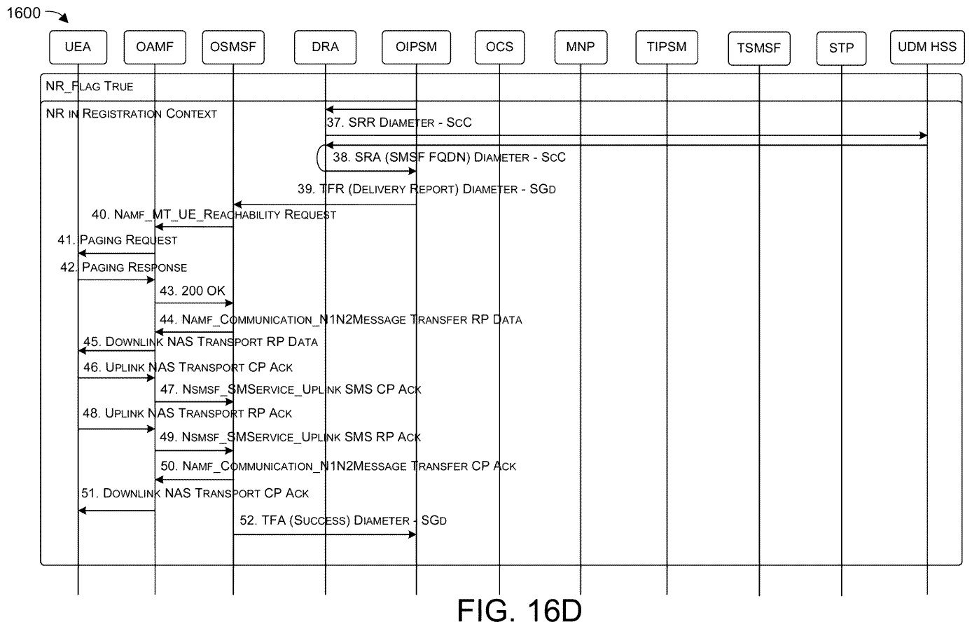

In an embodiment, is disclosed a 5G to 5G SMS procedure. FIGS. 16A-D illustrates an exemplary flow mechanism 1600 showing 5G to 5G Short Message Service (SMS) procedure, in accordance with an embodiment of the present disclosure. As illustrated, the steps include:
Steps 1-4: The SMS received over the NAS transport from the UE is forwarded by the AMF to the SMSF over Nsmsf interface. After successful inspection of the SMS and payload, the SMSF responds to the SMS with CP-ACK response.
Step 5: The SMSF forwards this message to the home IPSMGW which will be obtained by home PLMN of user. This can be achieved form the UE context saved during registration or SUPI received in the SMS. The SMSF may send this message over the Sgd interface in an OFR (MO-Forward-Short-Message Request) command.

Steps 6-7: The IPSMGW performs MNP dip to check the domain of a B party. If the MNP query is timed out, the IPSMGW sends error response in OFA (MO-Forward-Short-Message Answer) indicating SMS failure to the SMSF and that will be communicated to the AMF in Namf_Communication_NIN2MessageTransfer service operation as RP_error.
In case of successful response from the MNP, step no. 8 is followed.
Steps 8-9: The IPSMGW performs CCR (online charging request) and if it is unsuccessful, RP_ERROR is sent to UE as mentioned in steps 6-7.
Steps 10-14: In successful scenario, IPSMGW will send RP_ACK to AMF in Namf_Communication_NIN2MessageTransfer service operation.
Steps 15-17: When the SRI is relayed to term the IPSMGW, then it may check for the NR flag wherein the IPSMGW checks for the PANI header saved during registration and the NR location is received. In such case, the IPSMGW performs a SRR query even though IMS reg context is present. The SMSF address is received in the SRA and the IPSMGW will return self GT to receive MT FSM. It may be noted that, if NR flag is false, then the IPSMGW may route the traffic through CFX as per current implementation for 4G flow.
Steps 18-36: The term IPSMGW may terminate SMS over Sgd interface through the SMSF. On successful termination, CP-ack is received and is then transferred to orig IPSMGW over the MAP.
Steps 37-52: A delivery report is routed same as MT SMS.

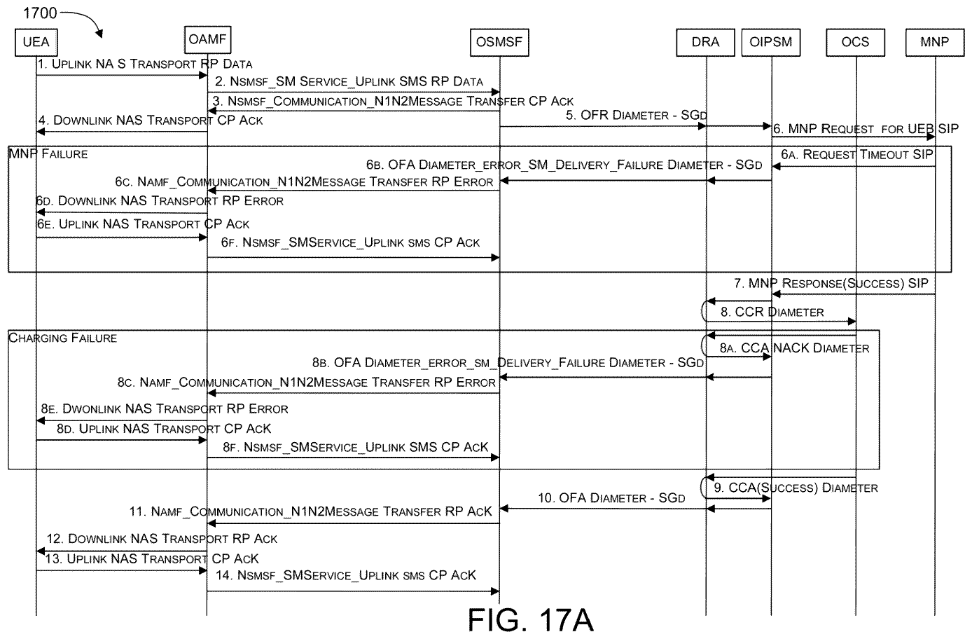

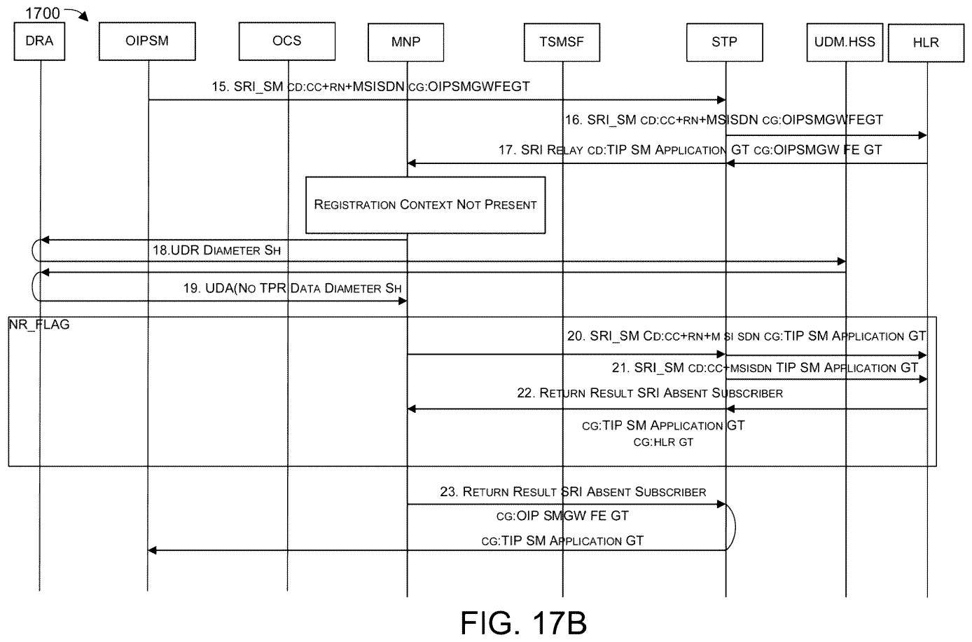

In an embodiment is disclosed a MO 5G to MT 5G unregistered user SMS procedure. FIGS. 17A-B illustrates an exemplary flow mechanism 1700 depicting 5G to 5G unregistered user SMS procedure, in accordance with an embodiment of the present disclosure. The steps are as follows:
Steps 1 to 14 are same as that of flow mentioned in 5G to 5G SMS procedure Steps 15 to 23: When the SRI is received and the user context is not present in the IPSMGW, then the IPSMGW performs UDR query to fetch user profile from the HSS. TIPSMGW may perform the SRI query towards B Party HLR for which HLR shall return an absent subscriber which may be returned to OIPSMGW.

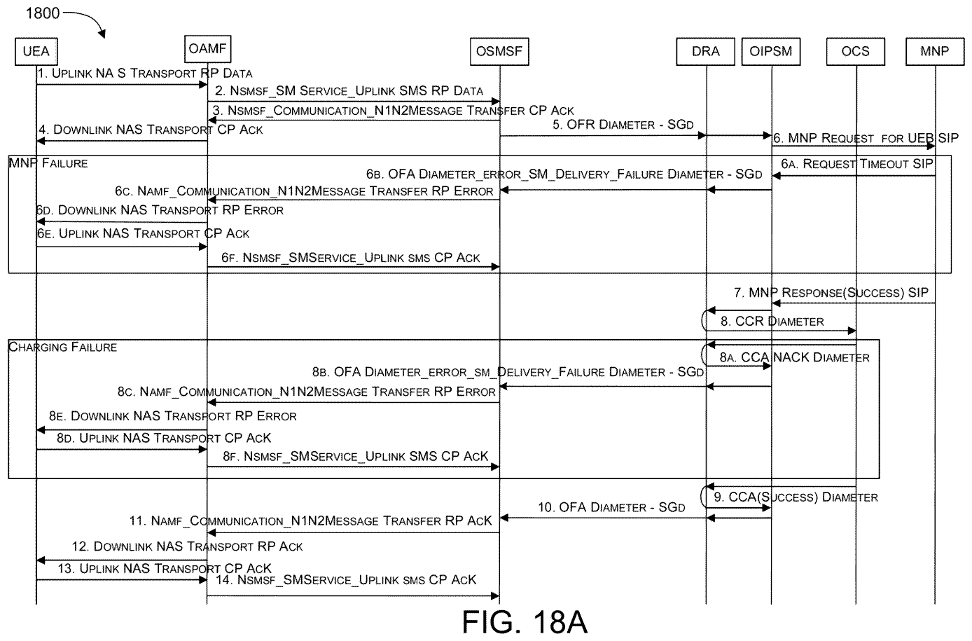

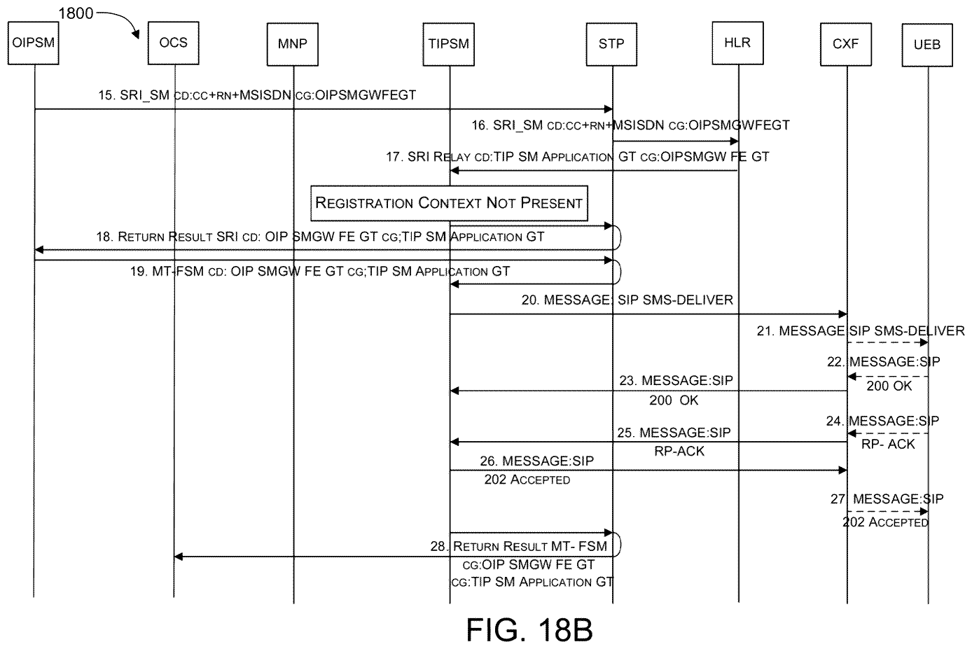

In an embodiment, is disclosed an exemplary 5G to 4G SMS procedure (one network technology to another network technology). FIGS. 18A-B illustrates an exemplary flow mechanism 1800 depicting 5G to 4G SMS procedure, in accordance with an embodiment of the present disclosure. The procedure is depicted below:
It may be noted that all the steps in this call flow are same as that of 5G to 5G flow with one change that the IPSMGW will receive the MME address from the HSS in the SRA. Thus, the message will be terminated through MME as B party is latched in 4G.
NOTE 2: In case delivery through MME fails for 4G user, O-IPSMGW will perform SRI query over SICGTRAN interface to find T-IPSMGW for SMS delivery.

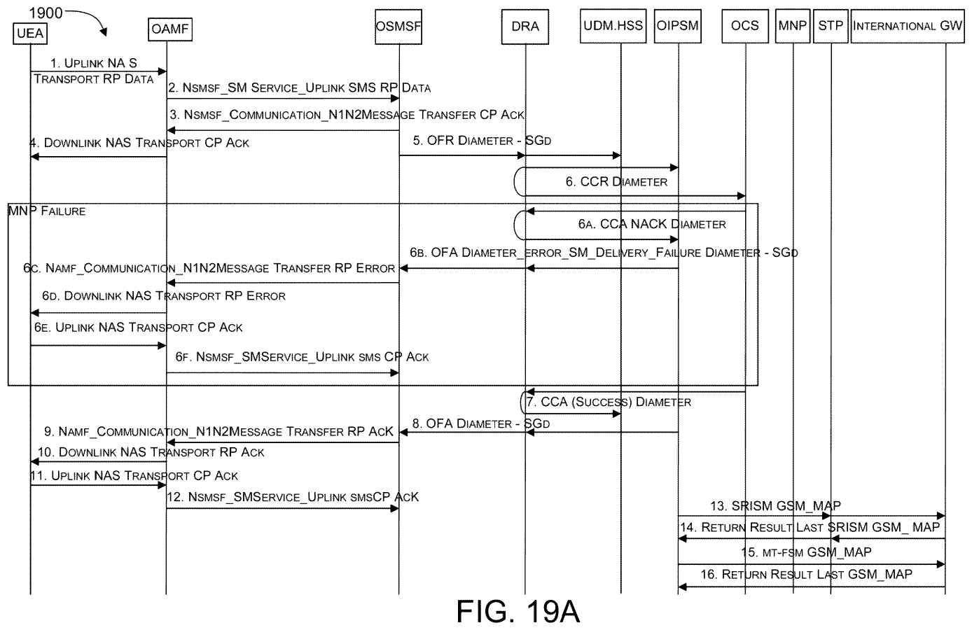

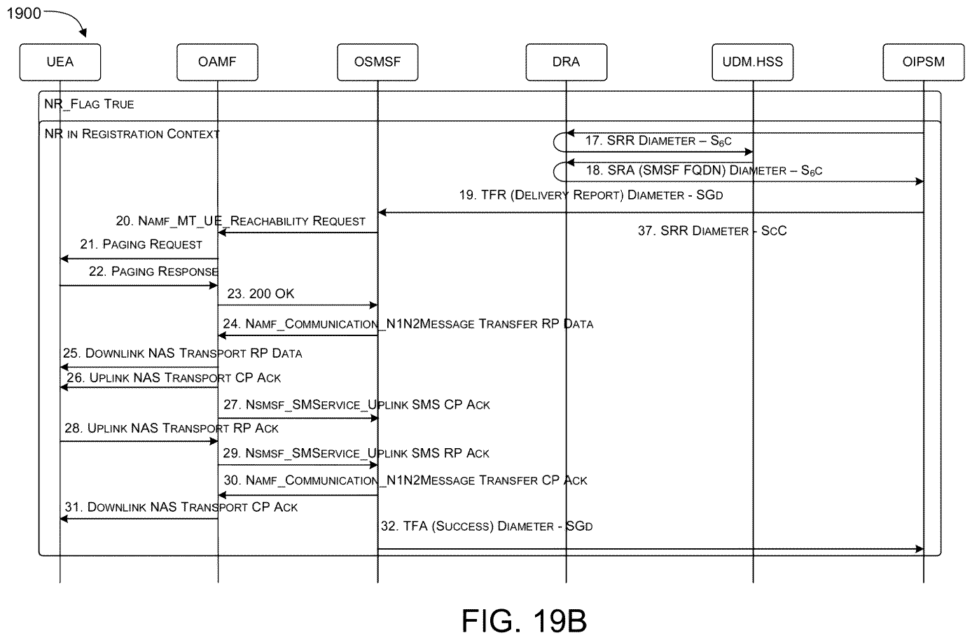

In an embodiment, is disclosed a 5G to international number SMS. FIGS. 19A-B illustrates an exemplary flow mechanism 1900 depicting a 5G subscriber to an international number SMS procedure, in accordance with an embodiment of the present disclosure. It may be noted that all the steps in this call flow are same as that of the 5G-to-5G flow with one change that the MNP for international number shall not be performed.

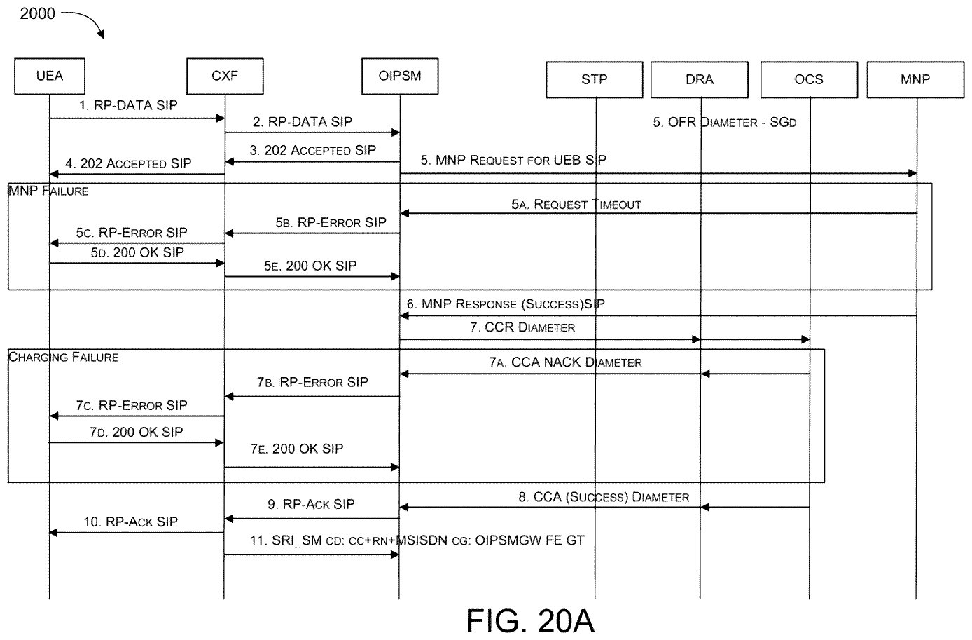

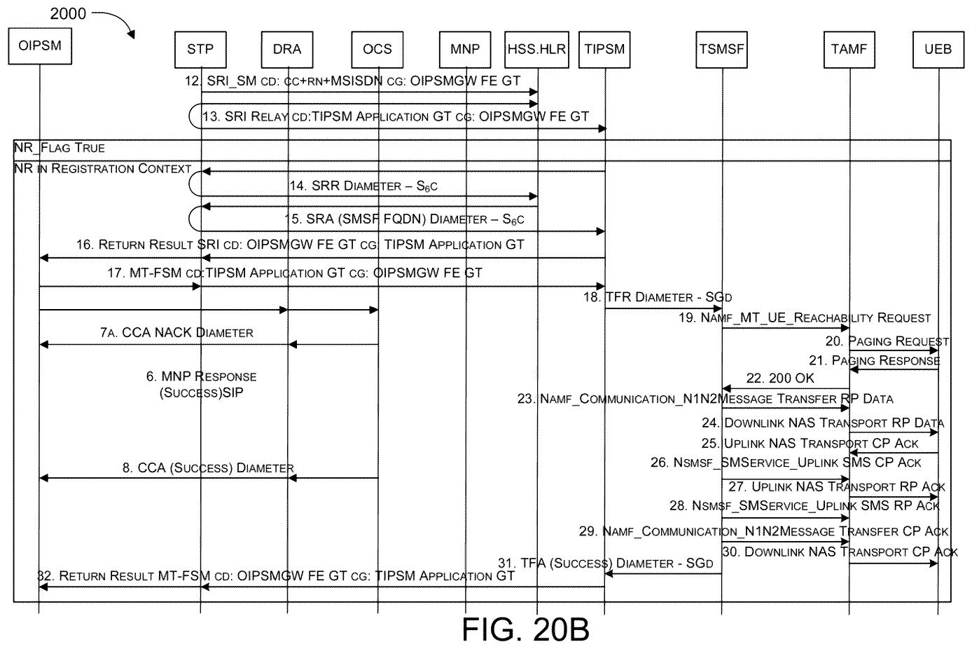

FIGS. 20A-B illustrates an exemplary flow mechanism 2000 showing a 4G to 5G SMS procedure, in accordance with an embodiment of the present disclosure. It is to be noted that all the steps in this call flow are same as that of 4G to 5G call flow but in a reverse sequence.

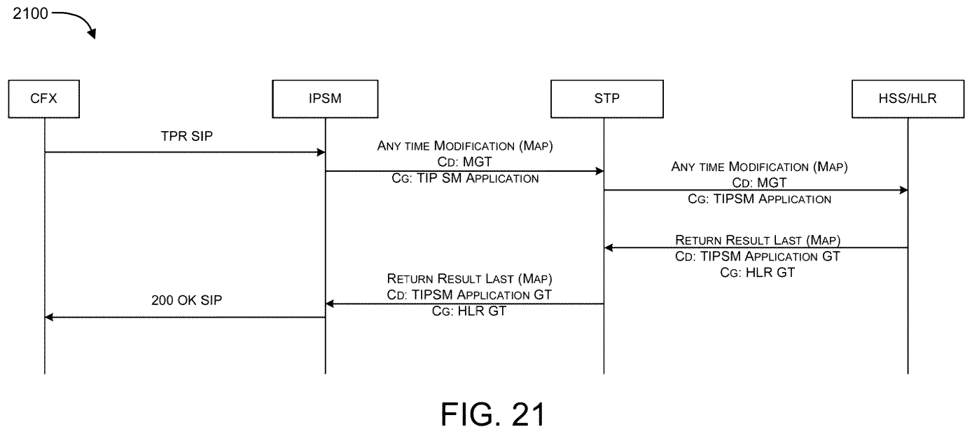

FIG. 21 illustrates an exemplary flow mechanism 2100 showing a registration flow for IP Multimedia Subsystem (IMS), in accordance with an embodiment of the present disclosure. The illustrated registration flow is used for IMS Registration for the IPSM.
Step 1: the CFX may send TRP SIP to the IPSM.
Step 2: the IPSM may send any time modification (MAP), CD: (MGT), CG: TIP SM application to the STP.
Step3: the STP may send any time modification (MAP), CD: (MGT), CG: TIP SM application to the HSS/HLR.
Step 4: the HSS/HLR may send result return last (MAP), CD: TIPSM application GT and CG: HLR GT to the STP.
Step 5: the STP may send result return last (MAP), CD: TIPSM application GT and CG: HLR GT to the IPSM.
Step 6: the IPSM may send 200 ok SIP.

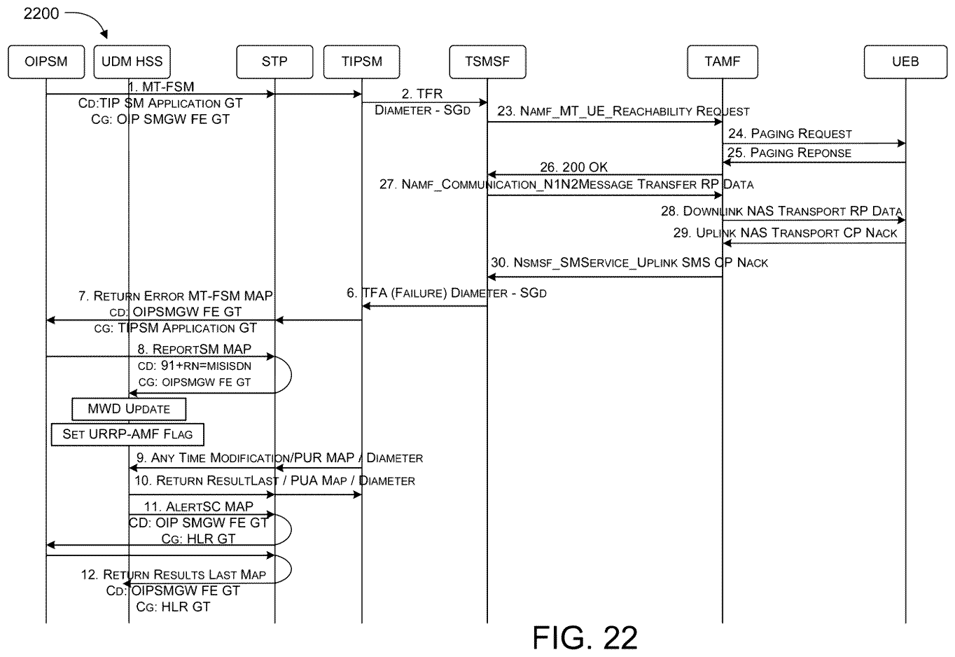

FIG. 22 illustrates an exemplary flow mechanism 2200 showing deferred delivery for the 5G user, in accordance with an embodiment of the present disclosure.

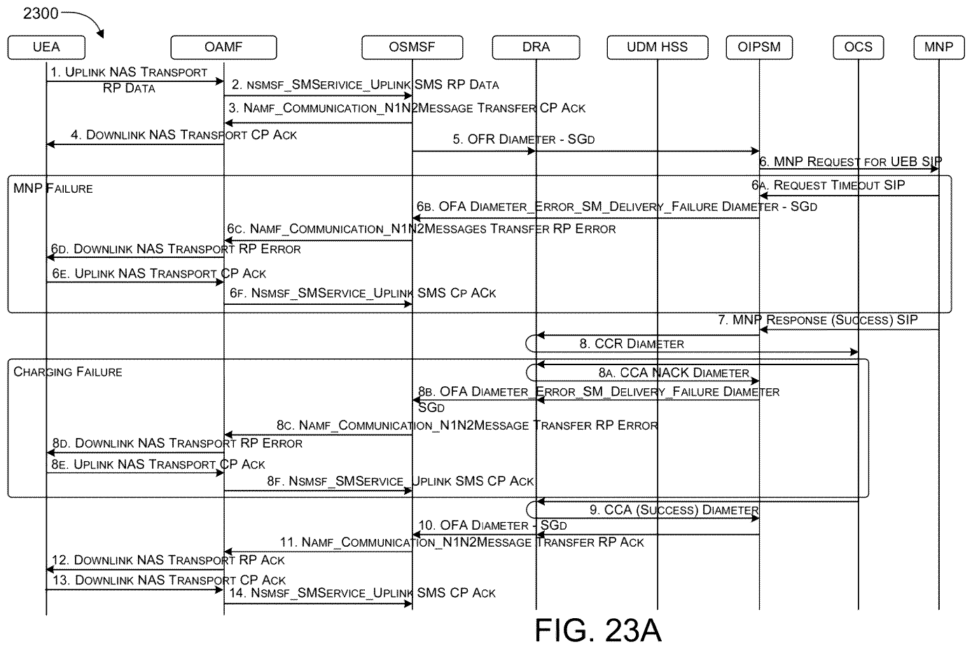

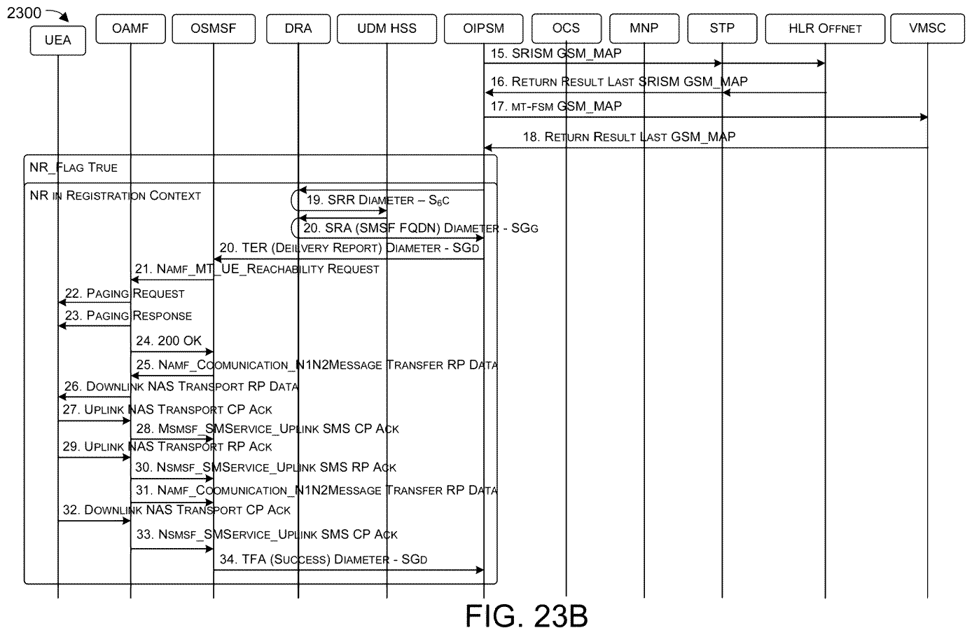

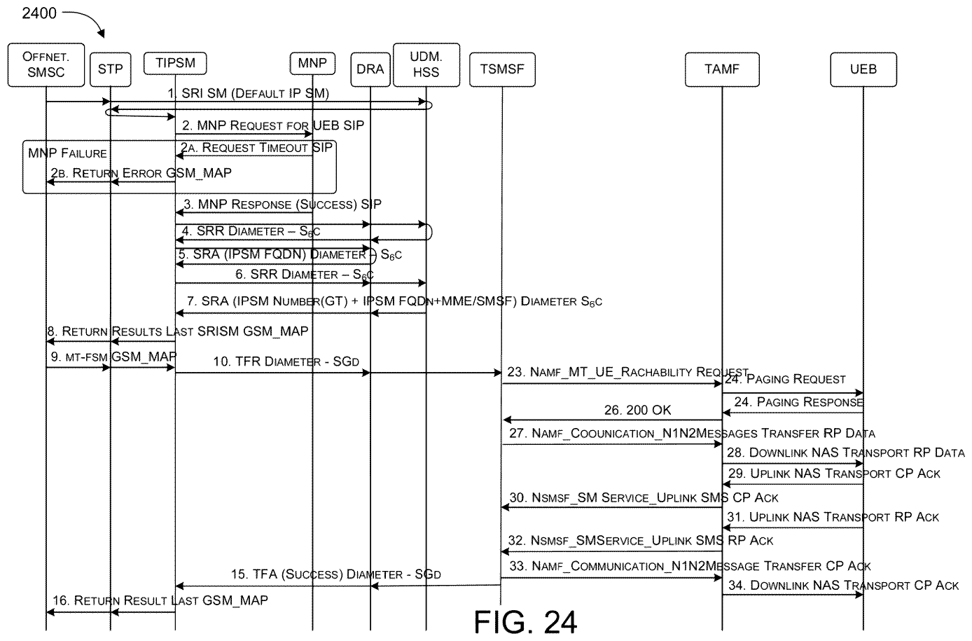

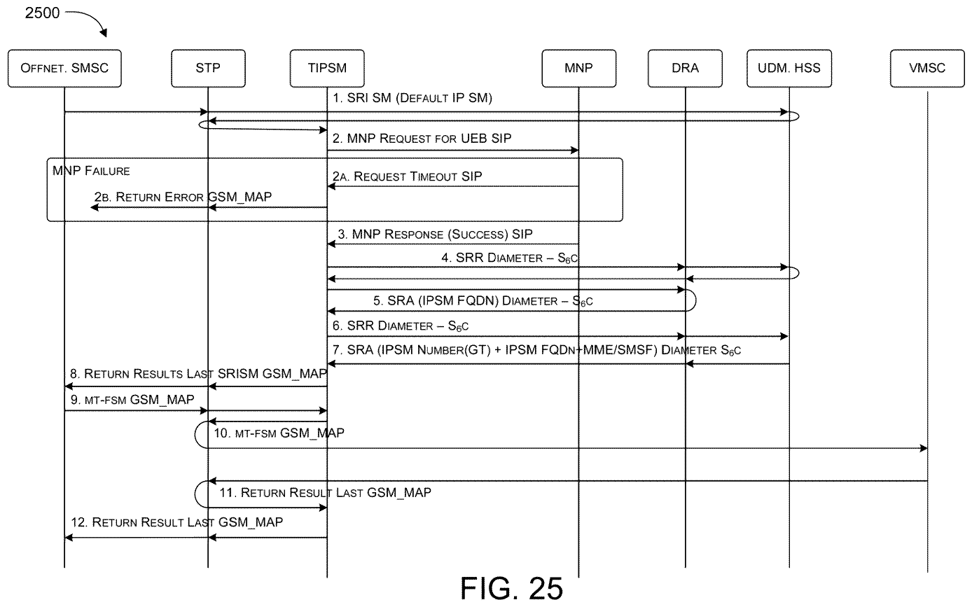

FIGS. 23A-B illustrates an exemplary 5G to offnet (2G/3G) SMS flow mechanism 2300, in accordance with an embodiment of the present disclosure. It may be noted that all the steps in this call flow are same as that of 5G to 4G call flow except for getting location for offnet MSC. For the same, the IPSM may initiate the SRI_SM procedure with the HLR which will return the current vMSC address that may be used for forwarding the Mobile Terminated Forward Short Message (MT-FSM).
1) Offnet (2G/3G) to 5G Subscriber SMS flow. FIG. 24 illustrates an exemplary offnet (2G/3G) to 5G SMS flow mechanism 2400, in accordance with an embodiment of the present disclosure.
2) Offnet (2G/3G) to International Outroamer. FIG. 25 illustrates an exemplary offnet (2G/3G) to international subscriber SMS flow mechanism 2500, in accordance with an embodiment of the present disclosure.
   Steps 1 to 2b: First refers to steps 1 to 2b of the offnet to 5G SMS flow.
   Steps 3 to 8: When success response of the MNP query is received, the IPSMGW performs SRR to fetch the SMSF address if any. As the user is an international outroamer, the UDM may not return any serving node address in the SRA. Thus, the IPSMGW may initiate new SRI towards the HLR to find Visiting MSC (VMSC) address. The HLR may return the VMSC GT in a SRI response. After this step, the IPSMGW may respond to relayed SRI received from offnet SMSC with its own GT.
   Steps 9 to 12: Offnet SMSC may send MT_FSM to the IPSMGW and this may be delivered to the VMSC as per current IMS implementation.

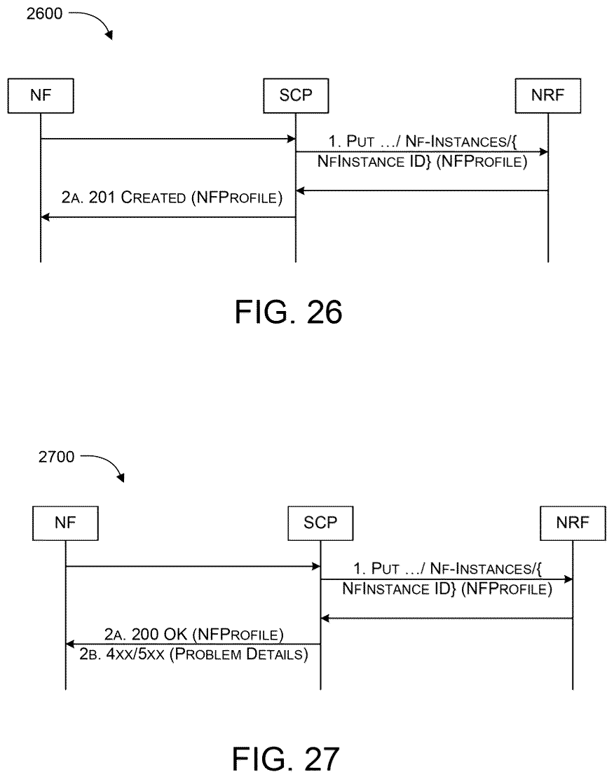

In an embodiment, is disclosed a SMSF-NRF Registration process. This registration allows the SMSF instance to register its NF profile in the NRF. This includes registration of general parameters of the SMSF instance, together with the list of services exposed by the SMSF instance. This service operation is not allowed to be invoked from the NRF in a different PLMN. FIG. 26 illustrates an exemplary Network Function (NF) registration flow mechanism 2600, in accordance with an embodiment of the present disclosure.
Step 1: The NF Service Consumer (SMSF) may send a PUT request to resource URI representing the NF Instance. The URI is determined by the NF Instance. The variable {nfInstanceID} represents an identifier, provided by the NF service consumer that may be globally unique inside the PLMN of the NRF where the NF is being registered. The format of the NF Instance ID may be a Universally Unique Identifier (UUID) version 4, as described in IETF RFC 4122 [18].
   EXAMPLE: UUID version 4: “4947a69a-f61b-4bc1-b9da-47c9c5d14b64”
   The payload body of the PUT request may contain a representation of the NF instance to be created.
Step 2: On success, “201 Created” may be returned, the payload body of the PUT response may contain representation of a created resource and the “Location” header may contain the URI of the created resource. Additionally, the NRF returns a “heart-beat timer” containing number of seconds expected between two consecutive heart-beat messages from an NF instance to the NRF. Representation of the created resource may be a complete NF profile or a NF profile just including mandatory attributes of the NF Profile and attributes which the NRF added or changed.
   If the registration of the NF instance fails at the NRF due to errors in encoding of the NFProfile JSON object, the NRF may return “400 Bad Request” status code with ProblemDetails IE providing details of the error.
   If the registration of the NF instance fails at the NRF due to NRF internal errors, the NRF may return “500 Internal Server Error” status code with the ProblemDetails IE providing details of the error.
   During the registration of a network function instance with a custom NF type, the NF instance may provide NF-specific data (in the “customInfo” attribute) that may be stored by the NRF as part of the NF profile of the NF instance.
   The NRF may accept registration of the NF instances containing vendor-specific attributes, and therefore, it may accept NF profiles containing attributes whose type may be unknown to the NRF, and those attributes may be stored as part of the NF's profile data in the NRF.

In an embodiment, is disclosed a SMSF-NRF NFUpdate process. This allows an NF Instance (SMSF) to replace, or update partially, the parameters of its NF profile (including the parameters of the associated services) in the NRF. This also allows to add or delete individual services offered by the NF Instance. This service operation is not allowed to be invoked from the NRF in a different PLMN. FIG. 27 illustrates an exemplary NF update flow mechanism (showing complete replacement) 2700, in accordance with an embodiment of the present disclosure. To perform a complete replacement of the NF profile of a given NF instance, the NF service consumer may issue an HTTP PUT request.
Step 1: The NF Service Consumer (SMSF) may send a PUT request to a resource URI representing the NF Instance. Payload body of the PUT request may contain a representation of the NF Instance (SMSF) to be completely replaced in the NRF.
Step 2a: On success, “200 OK” may be returned, the payload body of the PUT response shall contain the representation of the replaced resource. The representation of the replaced resource may be a complete NF Profile or a NF Profile just including the mandatory attributes of the NF Profile and the attributes which the NRF added or changed.
Step 2b: If the update of the NF instance fails at the NRF due to errors in the encoding of the NFProfile JSON object, the NRF may return “400 Bad Request” status code with the ProblemDetails IE providing details of the error. If the update of the NF instance fails at the NRF due to NRF internal errors, the NRF shall return “500 Internal Server Error” status code with the ProblemDetails IE providing details of the error.

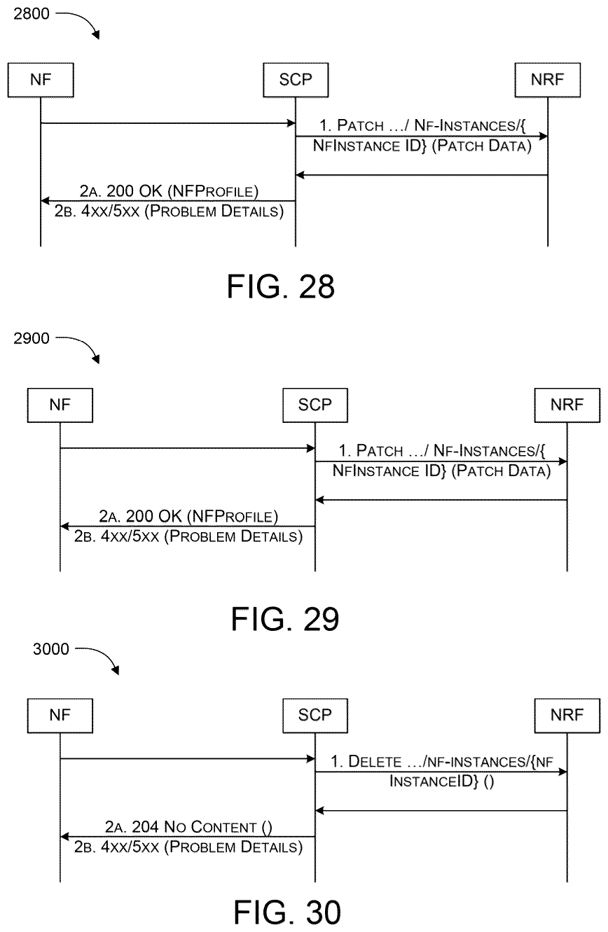

FIG. 28 illustrates an exemplary NF update flow mechanism (showing partial replacement) 2800, in accordance with an embodiment of the present disclosure. To perform a partial update of the NF Profile of a given NF instance (SMSF), the NF service consumer may issue an HTTP PATCH request. This partial update may be used to add/delete/replace individual parameters of the NF instance (SMSF), and also to add/delete/replace any of the services (and their parameters) offered by the NF Instance (SMSF).
Step 1: The NF Service consumer (SMSF) may send a PATCH request to a resource URI representing the NF instance. The payload body of the PATCH request may contain a list of operations (add/delete/replace) to be applied to the NF Profile of the NF instance; these operations may be directed to individual parameters of the NF Profile or to a list of services (and their parameters) offered by the NF Instances. In order to leave the NF profile in a consistent state, all the operations specified by the PATCH request body may be executed atomically.
Step 2a: On success, “200 OK” may be returned, the payload body of the PATCH response shall contain the representation of the replaced resource.
Step 2b: If the NF Instance, identified by the “nfInstanceID”, is not found in the list of registered NF Instances in the NRF's database, the NRF may return “404 Not Found” status code with the ProblemDetails IE providing details of the error.

In an embodiment, is disclosed a SMSF-NRF NF Heart-Beat procedure. Each NF including the SMSF that was previously registered in the NRF may contact the NRF periodically (heart-beat), by invoking the NFUpdate service operation, in order to show that the NF is still operative. The time interval at which the NRF may be contacted is deployment-specific, and it is returned by the NRF to the NF Service Consumer (SMSF) as a result of a successful registration.

When the NRF detects that a given NF has not updated its profile for a configurable amount of time (longer than the heart-beat interval), the NRF may change the status of the NF to SUSPENDED and consider that the NF and its services can no longer be discovered by other NFs via the NFDiscovery service. The NRF may notify NFS subscribed to receiving notifications of changes of the NF profile that the NF status has been changed to SUSPENDED. FIG. 29 illustrates an exemplary NF Heart-Beat flow mechanism 2900, in accordance with an embodiment of the present disclosure.
Step 1: The NF Service Consumer (SMSF) may send a PATCH request to the resource URI representing the NF Instance. The payload body of the PATCH request may contain a “replace” operation on the “nfStatus” attribute of the NF Profile of the NF Instance, and set it to the value “REGISTERED” or “UNDISCOVERABLE”.
In addition, the NF service consumer may also provide load information of the NF, and/or the load information of the NF associated NF services. The provision of such load information may be limited by this NF via appropriate configuration (e.g. granularity threshold) in order to avoid notifying minor load changes.
Step 2a: On success, the NRF may return “204 No Content”; the NRF may also answer with “200 OK” along with the full NF Profile, e.g. in cases where the NRF determines that the NF profile has changed significantly since the last heart-beat, and wants to send the new profile to the NF Service Consumer (SMSF).
Step 2b: If the NF Instance, identified by the “nfInstanceID”, is not found in the list of registered NF Instances in the NRF's database, the NRF shall return “404 Not Found” status code with the ProblemDetails IE providing details of the error.

SMSF-NRF NFDeregister: This service operation may remove profile of a NF (SMSF) previously registered in the NRF. It is executed by deleting a given resource identified by a “NF Instance ID”. The operation is invoked by issuing a DELETE request on the URI representing the specific NF Instance. FIG. 30 illustrates an exemplary NF deregister flow mechanism 3000, in accordance with an embodiment of the present disclosure.
Step 1: The NF Service Consumer shall send a DELETE request to the resource URI representing the NF Instance (NRF). The request body shall be empty.
Step 2a: On success, “204 No Content” shall be returned. The response body shall be empty.
Step 2b: If the NF Instance, identified by the “nfInstanceID”, is not found in the list of registered NF Instances in the NRF's database, the NRF shall return “404 Not Found” status code with the ProblemDetails IE providing details of the error

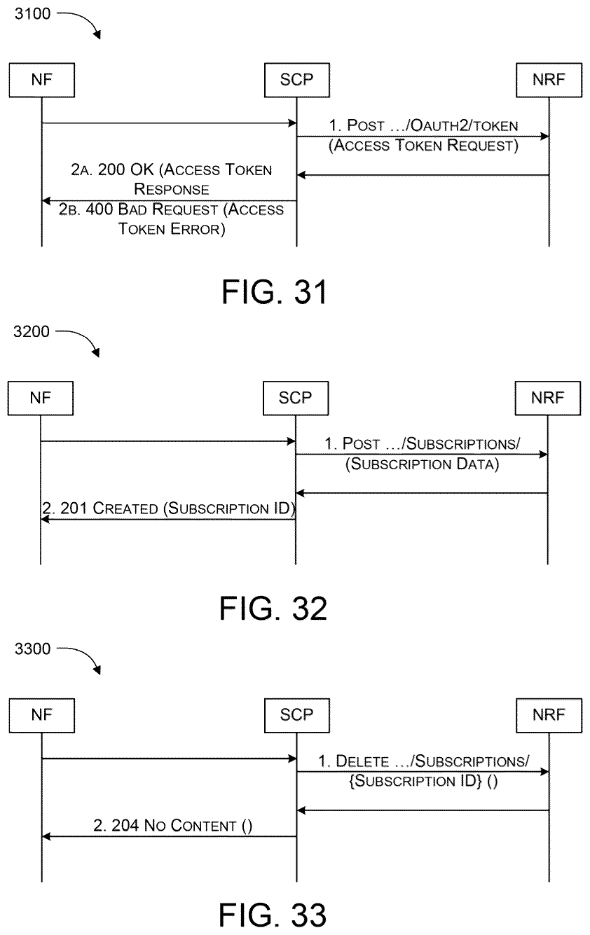

SMSF-NRF AccessToken: This service operation is used by an NF Service Consumer to request an OAuth2 access token from the authorization server (NRF). FIG. 31 illustrates an exemplary flow mechanism 3100 showing NF AccessToken Request, in accordance with an embodiment of the present disclosure.
Step 1: The NF Service Consumer may send a POST request to the “Token Endpoint”, The “Token Endpoint” URI shall be:
{nrfApiRoot}/oauth2/token
The OAuth 2.0 access token request includes in the body of the HTTP POST request may contain:
   An OAuth2 grant type set to “client_credentials”;
   The “scope” parameter indicating the names of the NF Services that the NF Service Consumer is trying to access (i.e., the expected NF service names);
   The NF Instance Id of the NF Service Consumer requesting the OAuth2.0 access token, if this is an access token request for a specific NF Service Producer;
   NF type of the NF Service Consumer, if this is an access token request not for a specific NF Service Producer;
   NF type of the expected NF Service Producer, if this is an access token request for a specific NF Service Producer;
   The NF Instance Id of the expected NF Service Producer, if this is an access token request for a specific NF Service Producer;
   Home and Serving PLMN IDs, if this is an access token request for use in roaming scenarios.
Step 2: On success, “200 OK” shall be returned, the payload body of the POST response shall contain the requested access token and the token type set to value “Bearer”.

In an embodiment, is disclosed a SMSF-NRF NFStatusSubscribe and NFStatusUnSubscribe procedure. NFStatusSubscribe allows an NF Instance to subscribe to changes on the status of NF Instances registered in NRF. This service operation can be invoked by an NF Instance in a different PLMN (via the local NRF in that PLMN). FIG. 32 illustrates an exemplary flow mechanism 3200 showing NF Status Subscribe, in accordance with an embodiment of the present disclosure.

NFStatusUnSubscribe allows an NF Instance to unsubscribe to changes on the status of NF Instances Registered in NRF. This service operation can be invoked by an NF Instance in a different PLMN (via the local NRF in that PLMN). FIG. 33 illustrates an exemplary flow mechanism 3300 showing NF Status UnSubscribe, in accordance with an embodiment of the present disclosure.

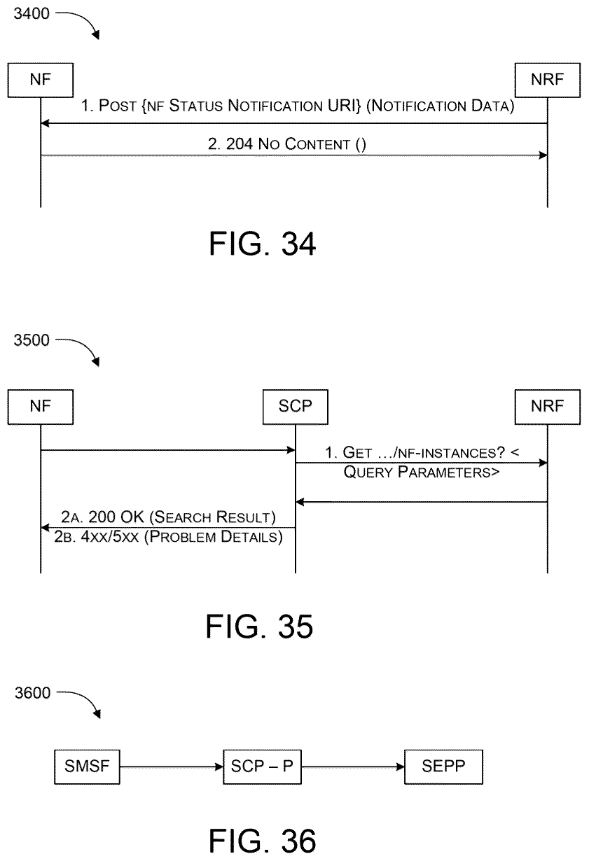

SMSF-NRF NFStatusNotify: NFStatusNotify allows the NRF to notify subscribed NF Instances of changes on the status of NF Instances. This service operation can be invoked by an NF Instance in a different PLMN (via the local NRF in that PLMN). FIG. 34 illustrates an exemplary flow mechanism 3400 showing NF StatusNotify, in accordance with an embodiment of the present disclosure.

SMSF-NRF NFDiscovery: The Nnrf_NFDiscovery service allows a NF (SMSF) or SCP instance to discover other NF Instances with the potential services they offer, by querying the local NRF. It also allows an NRF in a PLMN to re-issue a discovery request towards an NRF in another PLMN (e.g., the HPLMN of a certain UE). It provides to the NF service consumer (SMSF) or SCP the profile (including IP address or FQDN) of the NF Instance or NF Services matching certain input criteria.

Before a service consumer invokes this service operation, it shall consider if it is possible to reuse the results from a previous searching (service discovery). The service consumer should reuse the previous result if input query parameters in the new service discovery request are the same as used for the previous search and the validity period of the result is not expired. The service consumer may consider reusing the previous result if the attributes as required for the new query is also part of NF profile of the candidates NFs from a previous query. In such case, when the results of a previous query are reused, the service consumer need consider that the results, e.g., in terms of the number of discovered NFs, can be different than the potential results obtained after performing a new query. FIG. 35 illustrates an exemplary flow mechanism 3500 showing NF discovery request, in accordance with an embodiment of the present disclosure.
Step 1: The NF Service Consumer (SMSF) shall send an HTTP GET request to the resource URI “nf-instances” collection resource. The input filter criteria for the discovery request shall be included in query parameters.
Step 2a: On success, “200 OK” shall be returned. The response body shall contain a validity period, during which the search result can be cached by the NF Service Consumer (SMSF), and an array of NF Profile objects, that satisfy the search filter criteria (e.g., all NF Instances offering a certain NF Service name).
Step 2b: If the NF Service Consumer is not allowed to discover the NF services for the requested NF type provided in the query parameters, the NRF shall return “403 Forbidden” response.
If the discovery request fails at the NRF due to errors in the input data in the URI query parameters, the NRF shall return “400 Bad Request” status code with the ProblemDetails IE providing details of the error. If the discovery request fails at the NRF due to NRF internal errors, the NRF shall return “500 Internal Server Error” status code with the ProblemDetails IE providing details of the error

SEPP Integration: The SMSF supports integration with the SEPP. Following points are to be considered here.
SMSF and SEPP integration is done for supporting all communication for foreign users/PLMNs.
All communication with foreign UDM will be through SCP (egress and ingress) and SEPP

FIG. 36 illustrates an exemplary flow mechanism 3600 showing SMSF-Security Edge Protection Proxy (SEPP) integration in accordance with an embodiment of the present disclosure. The SMSF may perform the discovery of foreign PLMN UDM from local NRF as part of NRF Discovery flow. Post that NRF may provide discovery response including the foreign PLMN FQDN.
While sending message towards SCP-C, SMSF will make following changes for foreign PLMN
   Authority: Foreign UDM Address including PLMN from Discovery data (Option to send SEPP address)
   3gpp-Sbi-Target-apiroot: Foreign UDM Address including PLMN
   Discovery-target-plmn-list: PLMN of foreign UDM
   For Subscription message, 3gpp-Sbi-binding header will be included with SMSF Set ID (SMSF setID mapping to be maintained at SEPP. This will be used while routing Notification to SMSF cluster.)
   Notification URL in Subscribe with be SMSF FQDN.
   Incoming Notify from SEPP may contain “3gpp-Sbi-Routing-Binding” header. If not sent by Foreign PLMN than SEPP will need to add this header with value as SMSF Set ID.

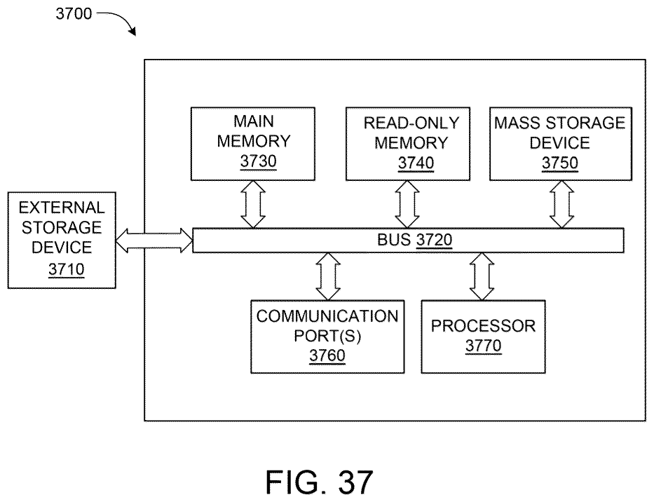

FIG. 37 illustrates an exemplary computer system 3700 in which or with which embodiments of the present disclosure may be implemented. As shown in FIG. 37, the computer system 3700 may include an external storage device 3710, a bus 3720, a main memory 3730, a read-only memory 3740, a mass storage device 3750, communication port(s) 3760, and a processor 3770. A person skilled in the art will appreciate that the computer system 3700 may include more than one processor and communication ports. The processor 3770 may include various modules associated with embodiments of the present disclosure. The communication port(s) 3760 may be any of an RS-232 port for use with a modem based dialup connection, a 10/100 Ethernet port, a Gigabit or 10 Gigabit port using copper or fiber, a serial port, a parallel port, or other existing or future ports. The communication port(s) 3760 may be chosen depending on a network, such a Local Area Network (LAN), Wide Area Network (WAN), or any network to which the computer system 3700 connects. The main memory 3730 may be random access memory (RAM), or any other dynamic storage device commonly known in the art. The read-only memory 3740 may be any static storage device(s) e.g., but not limited to, a Programmable Read Only Memory (PROM) chips for storing static information e.g., start-up or BIOS instructions for the processor 3770. The mass storage device 3750 may be any current or future mass storage solution, which can be used to store information and/or instructions. Exemplary mass storage device 3750 includes, but is not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks.

The bus 3720 communicatively couples the processor 3770 with the other memory, storage, and communication blocks. The bus 3720 may be, e.g. a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor 3770 to the computer system 3700.

Optionally, operator and administrative interfaces, e.g. a display, keyboard, joystick, and a cursor control device, may also be coupled to the bus 3720 to support direct operator interaction with the computer system 3700. Other operator and administrative interfaces can be provided through network connections connected through the communication port(s) 3760. Components described above are meant only to exemplify various possibilities. In no way should the aforementioned exemplary computer system 3700 limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure supports communication of 5G Non-Access Stratum (NAS) messages using a Short Message Service Function (SMSF).

The present disclosure enables the SMSF to transfer a SMS over the NAS.

The present disclosure enables the SMSF to relay a message between a User Equipment (UE) and a Short Message Service Center (SMSC) through Access and Mobility Management Function (AMF).

The present disclosure enable the SMSF to serve as an interface and bridge between a 5G core network and traditional SMSC for receiving and sending 5G NAS messages.

The present disclosure enables the SMSF to offer services to the AMF via an Nsmsf service based interface.

The present disclosure provides the SMSF architecture that is highly resilience and scalable.

The present disclosure the SMSF architecture that has no single point of failure which includes node level redundancy.

The present disclosure enables the SMSF to integrate with other network functions for Hyper Text Transfer Protocol (HTTP2) based interfaces both directly as well as via Service Communication Proxy (SCP).

The present disclosure enables load distribution of messages by the SCP on multiple SMSF blades.

The present disclosure enables multiple database nodes (3 master and 4 slaves) to provide full redundancy for session data.

The present disclosure provides Mobile Application Part (MAP) connectivity via a MAP Gateway (MAPGW) component.

The present disclosure provides support for disaster recovery SMSF using the SCP support.

The present disclosure supports zero touch installation through a central process.

We claim:

1. A method for providing node level redundancy for session data, the method comprising:
a short message service function (SMSF) cluster (100) including plurality of SMSF nodes on a primary site (204) with a service communication proxy (SCP) (202);
redirecting, by the SCP (202), the session data to other SMSF node from the plurality of SMSF nodes, on detecting one of the plurality of SMSF nodes fails/downs;
triggering, by the SMSF (100), a disaster recovery (DR) site (206), on detecting all the SMSF nodes fail/down; and
routing, by the SCP (202), the session data to the DR site (206), wherein
when the SMSF cluster (100) is restarted and ready to accept the session data, sending a command line interface (CLI) command from the SMSF (100) to the SCP (202) to shift back the session data to primary site (204).

2. The method as claimed in claim 1 further comprising integrating, by the SMSF (100), with plurality of network functions using a hypertext transfer protocol 2 (HTTP2) based interfaces both directly as well as via the SCP (202).

3. The method as claimed in claim 1 further comprising enabling, by the SMSF (100), load distribution of messages by the SCP on plurality of SMSF blades.

4. The method as claimed in claim 1, further comprising providing, by the SMSF (100), a mobile application part (MAP) connectivity via a mobile application part gateway (MAPGW) component.

5. The method as claimed in claim 1, further comprising offering, by the SMSF (100), services to an access management function (AMF) via a NSMSF service-based interface.

6. The method as claimed in claim 1, wherein the SCP (202) is configured to distribute the session data using a round robin algorithm for redundancy.

7. A method for providing database (DB) redundancy for traffic routing, the method comprising:
a short message service function (SMSF) cluster (100) containing plurality of DB nodes on a primary site (204) with a service communication proxy (SCP) (202), wherein the plurality of DB nodes includes plurality of pairs of master DB node and slave DB node and an additional slave DB node and the SCP (202) is configured to distribute the traffic using a round robin algorithm;
routing, by the SMSF (100), traffic to the additional slave DB node on detecting master DB node or slave DB node of one pair of plurality of pairs of master DB nodes and slave DB nodes fails or goes down;
routing, by the SMSF (100), traffic to the other pair of plurality of pairs of master DB nodes and slave DB nodes on detecting the one pair of plurality of pairs of master DB nodes and slave DB nodes fails or goes down; and
routing, by the SCP (202), traffic to a disaster recovery (DR) site (206) on detecting all pairs of master DB nodes and slave DB nodes fail or down and the additional slave DB node is not available, wherein when the SMSF cluster is restarted and ready to accept the traffic, sending a command line interface (CLI) command, by the SMSF (100), to the SCP (202) to shift back the traffic to the primary site (204).

8. The method as claimed in claim 7 the SMSF (100) is configured to integrate with plurality of network functions using a hypertext transfer protocol 2 (HTTP2) based interfaces both directly as well as via a service communication proxy (SCP).

9. The method as claimed in claim 7, the SMSF (100) is configured to perform load distribution of messages by the SCP on plurality of SMSF blades.

10. The method as claimed in claim 7, the SMSF (100) is configured to provide a mobile application part (MAP) connectivity via a mobile application part gateway (MAPGW) component.

11. The method as claimed in claim 7, the SMSF (100) is configured to offer services to an access management function (AMF) via a NSMSF service-based interface.

12. A system for providing node level redundancy for session data comprising:
a short message service function (SMSF) cluster (100) including plurality of SMSF nodes on a primary site (204) with a service communication proxy (SCP) (202), wherein the SCP (202) configured to distribute the session data using a round robin algorithm;
the SCP (202) configured to redirect the session data to other SMSF node from the plurality of SMSF nodes, on detecting one of the plurality of SMSF nodes fails/downs;
the SMSF (100) is configured to trigger a disaster recovery (DR) site (206), on detecting all the SMSF nodes fail/down;
the SCP (202) configured to route the session data to the DR site (206), wherein
when the SMSF cluster (100) is restarted and ready to accept the session data, the SMSF (100) configured to send a command line interface (CLI) command to the SCP (202) to shift back the session data to primary site (204).

13. A system for providing database (DB) redundancy for traffic routing comprising:
a short message service function (SMSF) cluster (100) containing plurality of DB nodes on a primary site (204) with a service communication proxy (SCP) (202), wherein the plurality of DB nodes includes plurality of pairs of master DB node and slave DB node and an additional slave DB node and the SCP (202) is configured to distribute the traffic using a round robin algorithm;
the SMSF (100) configured to route traffic to the additional slave DB node on detecting master DB node or slave DB node of one pair of plurality of pairs of master DB nodes and slave DB nodes fails or goes down;
the SMSF (100) configured to route traffic to the other pair of plurality of pairs of master DB nodes and slave DB nodes on detecting the one pair of plurality of pairs of master DB nodes and slave DB nodes fails or goes down; and
the SCP (202) configured to route traffic to a disaster recovery (DR) site (206) on detecting all pairs of master DB nodes and slave DB nodes fail or down and the additional slave DB node is not available, wherein when the SMSF cluster is restarted and ready to accept the traffic, sending a command line interface (CLI) command, by the SMSF (100), to the SCP (202) to shift back the traffic to the primary site (204).

14. A computer program product comprising a non-transitory computer-readable medium comprising instructions that, when executed by one or more processors, cause the one or more processors to execute a method for providing node level redundancy for session data, the method comprising:
a short message service function (SMSF) cluster (100) including plurality of SMSF nodes on a primary site (204) with a service communication proxy (SCP) (202), wherein the SCP (202) is configured to distribute the session data using a round robin algorithm;
redirecting, by the SCP (202), the session data to other SMSF node from the plurality of SMSF nodes, on detecting one of the plurality of SMSF nodes fails/downs;
triggering, by the SMSF, a disaster recovery (DR) site (206), on detecting all the SMSF nodes fail/down; and
routing, by the SCP (202), the session data to the DR site (206), wherein
when the SMSF cluster (100) is restarted and ready to accept the session data, sending a command line interface (CLI) command from the SMSF to the SCP (202) to shift back the session data to primary site (204).

15. A computer program product comprising a non-transitory computer-readable medium comprising instructions that, when executed by one or more processors, cause the one or more processors to execute a method for providing database (DB) redundancy for traffic routing, the method comprising:
a short message service function (SMSF) cluster (100) containing plurality of DB nodes on a primary site (204) with a service communication proxy (SCP) (202), wherein the plurality of DB nodes includes plurality of pairs of master DB node and slave DB node and an additional slave DB node and the SCP is configured to distribute the traffic using a round robin algorithm;
routing, by the SMSF (100), traffic to the additional slave DB node on detecting master DB node or slave DB node of one pair of plurality of pairs of master DB nodes and slave DB nodes fails or goes down;
routing, by the SMSF (100), traffic to the other pair of plurality of pairs of master DB nodes and slave DB nodes on detecting the one pair of plurality of pairs of master DB nodes and slave DB nodes fails or goes down; and
routing, by the SCP (204), traffic to a disaster recovery (DR) site (206) on detecting all pairs of master DB nodes and slave DB nodes fail or down and the additional slave DB node is not available, wherein when the SMSF cluster is restarted and ready to accept the traffic, sending a command line interface (CLI) command, by the SMSF (100), to the SCP (202) to shift back the traffic to the primary site (204).
